(19) United States
(12) Patent Application Publication
(10) Pub. No.: US 2026/0304472 A1
(43) Pub. Date: Oct. 1, 2026

(54) TXOP PROVISIONING IN TXSPG

(71) Applicant: Samsung Electronics Co., Ltd., Suwon-si (KR)

(72) Inventors: Rubayet Shafin, Frisco, TX (US); Boon Loong Ng, Plano, TX (US); Peshal Nayak, Plano, TX (US); Yue Qi, Plano, TX (US); Vishnu Vardhan Ratnam, Frisco, TX (US); Bilal Sadiq, Plano, TX (US)

(21) Appl. No.: 19/569,983

(22) Filed: Mar. 17, 2026

Related U.S. Application Data
(60) Provisional application No. 63/781,050, filed on Mar. 31, 2025.

(51) Int. Cl. H04W 74/0808

(52) U.S. Cl. CPC H04W 74/0808

(57) ABSTRACT

Methods and apparatuses for transmission opportunity (TXOP) provisioning in TXOP sharing for a peer to peer (P2P) group (TXSPG). A method performed by a non-access point (AP) station (STA) includes receiving, from an AP, a multi user (MU)-request to send (RTS) transmission opportunity sharing (TXS) trigger frame; identifying a time allocated to the P2P group based on an allocation duration subfield in the MU-RTS TXS trigger frame; and transmitting or receiving during the allocated time. The MU-RTS TXS trigger frame includes only one user info field that is not a special user info field. The non-AP STA is part of a P2P group.

### CROSS-REFERENCE TO RELATED APPLICATIONS AND CLAIM OF PRIORITY

This application claims priority under 35 U.S.C. § 119(e) to U.S. Provisional Patent Application No. 63/781,050 filed on Mar. 31, 2025. The above-identified provisional patent application is hereby incorporated by reference in their entirety.

### TECHNICAL FIELD

This disclosure relates generally to wireless networks. More specifically, this disclosure relates to a transmission opportunity (TXOP) provisioning in TXOP sharing for a peer to peer (P2P) group (TXSPG).

### BACKGROUND

WLAN technology allows devices to access the internet in the 2.4 GHZ, 5 GHZ, 6 GHZ or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax, etc.

### SUMMARY

This disclosure provides apparatuses and methods for TXOP provisioning in TXSPG.

In one embodiment, a method performed by a non-access point (AP) station (STA) is provided. The method includes receiving, from an AP, a multi user (MU)-request to send (RTS) transmission opportunity sharing (TXS) trigger frame; identifying a time allocated to the P2P group based on an allocation duration subfield in the MU-RTS TXS trigger frame; and transmitting or receiving during the allocated time. The MU-RTS TXS trigger frame includes only one user info field that is not a special user info field. The non-AP STA is part of a P2P group.

In another embodiment, a method performed by an AP is provided. The method includes transmitting, to an non-AP STA, a MU-RTS TXS trigger frame. The MU-RTS TXS trigger frame includes only one user info field that is not a special user info field. The non-AP STA is part of a P2P group. An allocation duration subfield in the MU-RTS TXS trigger frame indicates a time allocated to the P2P group for transmitting or receiving during the allocated time.

In yet another embodiment, a AP station STA is provided. The non-AP STA includes at least one processor including processing circuitry and memory storing instructions. The instructions, when executed by the at least one processor individually or collectively, cause the non-AP STA to receive, from an AP, a MU-RTS TXS trigger frame; identify a time allocated to the P2P group based on an allocation duration subfield in the MU-RTS TXS trigger frame; and transmit or receive during the allocated time. The MU-RTS TXS trigger frame includes only one user info field that is not a special user info field. The non-AP STA is part of a P2P group.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to various embodiments of the present disclosure;

FIG. 2A illustrates an example AP MLD according to various embodiments of the present disclosure;

FIG. 2B illustrates an example non-AP MLD according to various embodiments of this disclosure;

FIG. 3 illustrates an example network where infrastructure traffic and non-infrastructure traffic coexist according to embodiments of the present disclosure;

FIG. 4 illustrates an example frame sequence for TXOP allocation for P2P group according to embodiments of the present disclosure;

FIG. 5 illustrates an example method for TXOP allocation for a P2P group according to embodiments of the present disclosure;

FIG. 6 illustrates an example frame sequence for successful transmission of MU-RTS TXS trigger frame according to embodiments of the present disclosure;

FIG. 7 illustrates an example frame sequence for a UHR AP's transmission exception rule during the allocated TXOP to the P2P group due to solicited immediate response according to embodiments of the present disclosure;

FIG. 8 illustrates an example frame sequence for a UHR AP's transmission exception rule during the allocated TXOP to the P2P group due to reception of a CAS Control field according to embodiments of the present disclosure;

FIG. 9 illustrates an example method for a UHR AP's transmission exception rule during the allocated TXOP to the P2P group according to embodiments of the present disclosure;

FIG. 10A illustrates an example of format of a P2P element according to embodiments of the present disclosure;

FIG. 10B illustrates an example of control field format according to embodiments of the present disclosure;

FIG. 10C illustrates an example of P2P Group Info field format according to embodiments of the present disclosure;

FIG. 11A illustrates an example of HE variant User Info field format in the MU-RTS TXS Trigger frame according to embodiments of the present disclosure; and

FIG. 11B illustrates an example of EHT variant User Info field of MU-RTS TXS Trigger frame according to embodiments of the present disclosure.

### DETAILED DESCRIPTION

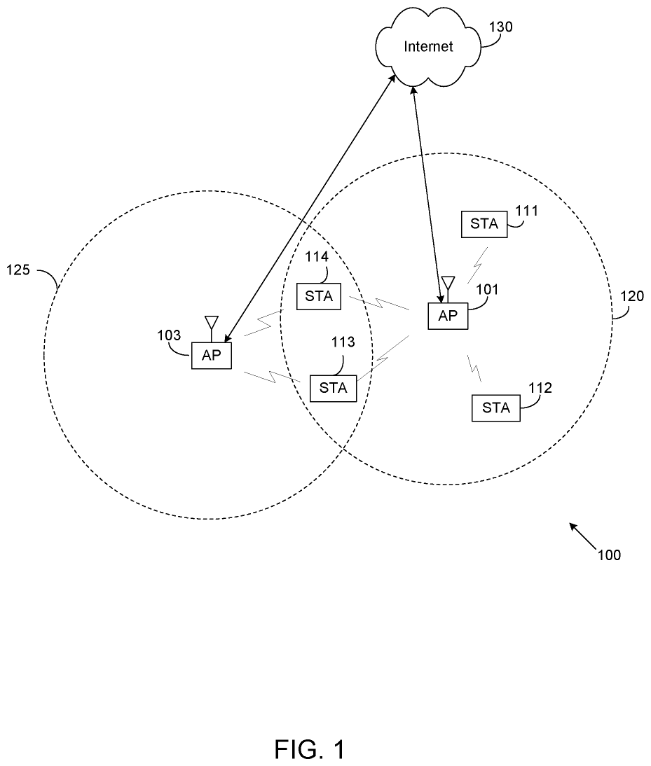

FIGS. 1 through 11B, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged system or device.

Existing WLAN standards support multiple bands of operation, where an AP and a non-AP device may communicate with each other, called links. Thus, both the AP and non-AP device may be capable of communicating on different bands/links, which is referred to as mutli-link operation (MLO). Devices capable of such MLO are referred to as multi-link devices (MLDs).

The following documents and standards descriptions are hereby incorporated into the present disclosure as if fully set forth herein: [1] IEEE P802.11be—D3.0 “Part 11: Wireless LAN Medium Access Control (MAC) and Physical Layer (PHY) Specifications—Amendment 8: Enhancements for extremely high throughput (EHT)” and [2] IEEE P802.11REVme-D2.1 “Part 11: Wireless LAN Medium Access Control (MAC) and Physical Layer (PHY) Specifications.”

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes APs 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for TXOP provisioning in TXSPG. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

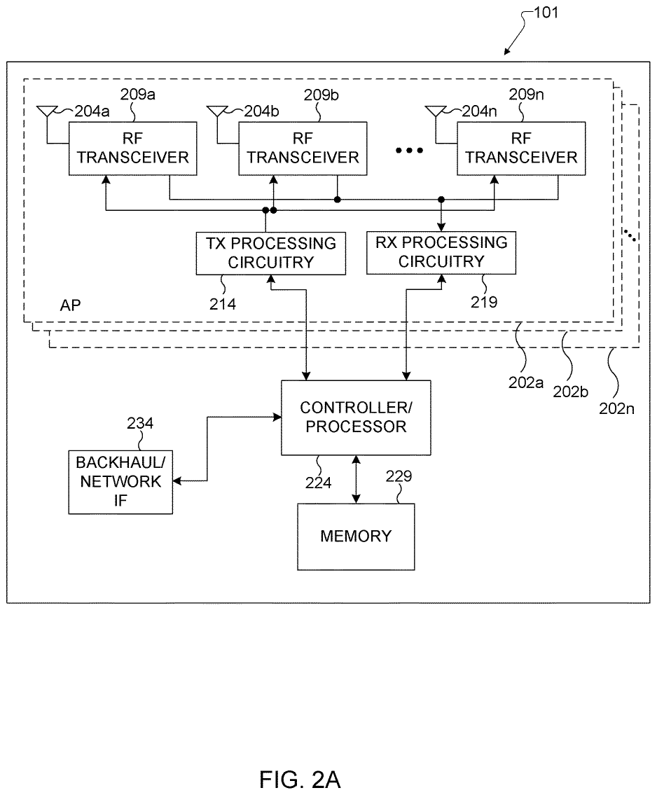

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. In one or more of the embodiments discussed below, the AP 101 is an AP MLD. However, APs come in a wide variety of configurations, and FIG. 2A does not limit the scope of this disclosure to any particular implementation of an AP.

The AP MLD 101 is affiliated with multiple APs 202a-202n (which may be referred to, for example, as AP1-APn). Each of the affiliated APs 202a-202n includes multiple antennas 204a-204n, multiple RF transceivers 209a-209n, transmit (TX) processing circuitry 214, and receive (RX) processing circuitry 219. The AP MLD 101 also includes a controller/processor 224, a memory 229, and a backhaul or network interface 234.

The illustrated components of each affiliated AP 202a-202n may represent a physical (PHY) layer and a lower media access control (LMAC) layer in the open systems interconnection (OSI) networking model. In such embodiments, the illustrated components of the AP MLD 101 represent a single upper MAC (UMAC) layer and other higher layers in the OSI model, which are shared by all of the affiliated APs 202a-202n.

For each affiliated AP 202a-202n, the RF transceivers 209a-209n receive, from the antennas 204a-204n, incoming RF signals, such as signals transmitted by STAs in the network 100. In some embodiments, each affiliated AP 202a-202n operates at a different bandwidth, e.g., 2.4 GHz, 5 GHZ, or 6 GHz, and accordingly the incoming RF signals received by each affiliated AP may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP 202a-202n operates at a different bandwidth, e.g., 2.4 GHz, 5 GHZ, or 6 GHz, the outgoing RF signals transmitted by each affiliated AP may be at a different frequency of RF.

The controller/processor 224 can include one or more processors or other processing devices that control the overall operation of the AP MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support orthogonal frequency division multiple access (OFDMA) operations in which outgoing signals are assigned to different subsets of subcarriers for different recipients (e.g., different STAs 111-114). Any of a wide variety of other functions could be supported in the AP MLD 101 by the controller/processor 224 including TXOP provisioning in TXSPG. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP MLD 101 to communicate with other devices or systems over a backhaul connection or over a network. The interface 234 could support communications over any suitable wired or wireless connection(s). For example, the interface 234 could allow the AP MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP MLD 101 may include circuitry and/or programming for TXOP provisioning in TXSPG. Although FIG. 2A illustrates one example of AP MLD 101, various changes may be made to FIG. 2A. For example, the AP MLD 101 could include any number of each component shown in FIG. 2A. As a particular example, an AP MLD 101 could include a number of interfaces 234, and the controller/processor 224 could support routing functions to route data between different network addresses. As another particular example, while each affiliated AP 202a-202n is shown as including a single instance of TX processing circuitry 214 and a single instance of RX processing circuitry 219, the AP MLD 101 could include multiple instances of each (such as one per RF transceiver) in one or more of the affiliated APs 202a-202n. Alternatively, only one antenna and RF transceiver path may be included in one or more of the affiliated APs 202a-202n, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. In one or more of the embodiments discussed below, the STA 111 is a non-AP MLD. However, STAs come in a wide variety of configurations, and FIG. 2B does not limit the scope of this disclosure to any particular implementation of a STA.

The non-AP MLD 111 is affiliated with multiple STAs 203a-203n (which may be referred to, for example, as STA1-STAn). Each of the affiliated STAs 203a-203n includes antenna(s) 205, a radio frequency (RF) transceiver 210, TX processing circuitry 215, and receive (RX) processing circuitry 225. The non-AP MLD 111 also includes a microphone 220, a speaker 230, a processor 240, an input/output (I/O) interface (IF) 245, an input 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives from the antenna(s) 205, an incoming RF signal transmitted by an AP of the network 100. In some embodiments, each affiliated STA 203a-203n operates at a different bandwidth, e.g., 2.4 GHz, 5 GHZ, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205. In embodiments wherein each affiliated STA 203a-203n operates at a different bandwidth, e.g., 2.4 GHz, 5 GHZ, or 6 GHZ, the outgoing RF signals transmitted by each affiliated STA may be at a different frequency of RF.

The processor 240 can include one or more processors and execute the basic OS program 261 stored in the memory 260 in order to control the overall operation of the non-AP MLD 111. In one such operation, the processor 240 controls the reception of forward channel signals and the transmission of reverse channel signals by the RF transceiver 210, the RX processing circuitry 225, and the TX processing circuitry 215 in accordance with well-known principles. The processor 240 can also include processing circuitry configured to facilitate TXOP provisioning in TXSPG. In some embodiments, the processor 240 includes at least one microprocessor or microcontroller.

The processor 240 is also capable of executing other processes and programs resident in the memory 260, such as operations for TXOP provisioning in TXSPG. The processor 240 can move data into or out of the memory 260 as required by an executing process. In some embodiments, the processor 240 is configured to execute a plurality of applications 262, such as applications for TXOP provisioning in TXSPG. The processor 240 can operate the plurality of applications 262 based on the OS program 261 or in response to a signal received from an AP. The processor 240 is also coupled to the I/O interface 245, which provides non-AP MLD 111 with the ability to connect to other devices such as laptop computers and handheld computers. The I/O interface 245 is the communication path between these accessories and the processor 240.

The processor 240 is also coupled to the input 250 and the display 255. The operator of the non-AP MLD 111 can use the input 250 to enter data into the non-AP MLD 111. The display 255 may be a liquid crystal display, light emitting diode display, or other display capable of rendering text and/or at least limited graphics, such as from web sites. The memory 260 is coupled to the processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted, and additional components could be added according to particular needs. In particular examples, one or more of the affiliated STAs 203a-203n may include any number of antenna(s) 205 for MIMO communication with an AP 101. In another example, the non-AP MLD 111 may not include voice communication or the processor 240 could be divided into multiple processors, such as one or more central processing units (CPUs) and one or more graphics processing units (GPUs). Also, while FIG. 2B illustrates the non-AP MLD 111 configured as a mobile telephone or smartphone, non-AP MLDs can be configured to operate as other types of mobile or stationary devices.

Embodiments of the present disclosure recognize and take into consideration that support for low-latency applications is desired in WLAN systems. Numerous devices may operate on the same network. Many of such devices may be latency-tolerant but still contend with the devices with low-latency applications for the same time and frequency resources. In some cases, the AP as the network controller may not have enough control over the unregulated/unmanaged traffic that contend with the low-latency traffic within the infrastructure basic service set (BSS). Some of the unmanaged traffic that interfere with the AP's BSS' latency sensitive traffic may be coming from uplink (UL)/downlink (DL) or direct link communications within the infrastructure BSS that the AP manages. Other's traffic interference may be due to transmission in the neighboring infrastructure BSS (OBSS). Yet other's traffic interference may be coming from neighboring independent BSS or P2P networks.

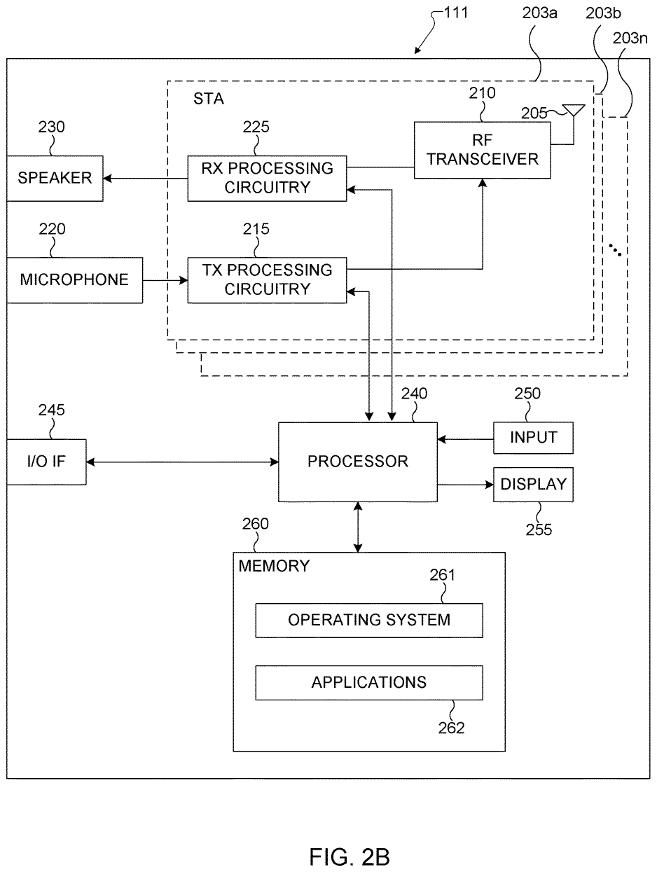

FIG. 3 illustrates an example network 300 where infrastructure traffic and non-infrastructure traffic coexist according to embodiments of the present disclosure. The network 300 is an example of the network 100 in FIG. 1. The network 300 is for illustration only and other embodiments can be used without departing from the scope of the present disclosure.

As illustrated, various STAs are present in the network 300. Certain of the STAs are connected to or associated with the AP. In this manner, the traffic between the associated STAs and the APs may be considered infrastructure traffic. Others of the STAs in the network 300 are not associated with the AP and may communicate directly with one another and/or with an associated STA using P2P communication. P2P communication represents a significant advancement in IEEE 802.11 WLANs, commonly known as Wi-Fi. Wi-Fi networks may rely on an AP to mediate communications between devices. In contrast, P2P communication enables direct data transmission between devices without the need for an intermediate AP. This direct communication is facilitated by standards such as Wi-Fi Direct, which allows devices to establish connections and communicate directly, enhancing efficiency and reducing latency.

The concept of P2P groups extends this capability, enabling multiple devices to form a network where each device can communicate directly with every other member of the group. This setup is particularly useful for applications like file sharing, multiplayer gaming, and streaming media within a local network. The formation of such groups typically involves discovery mechanisms that allow devices to identify potential peers and negotiate group membership. Security is paramount in these groups, ensuring that only authorized devices can join and participate.

There are multiple benefits of P2P groups. By eliminating the need for an AP, they reduce latency and conserve battery life on devices. This makes them good for scenarios requiring real-time communication or energy efficiency. Additionally, P2P groups enable innovative applications such as smart home systems and IoT networks, where direct device interaction is important.

Despite these advantages, embodiments of the present disclosure recognize that challenges exist in managing P2P groups. Coordinating multiple devices without a central AP requires sophisticated mechanisms to allocate resources like bandwidth fairly. Ensuring seamless group management when devices join or leave is also essential to maintain uninterrupted communication.

Standards within the 802.11 family, such as Wi-Fi Direct and potentially other specifications like 802.11z, may provide some framework for these P2P capabilities. These standards ensure compatibility and security, often incorporating encryption methods like WPA2 or WPA3 to protect data integrity.

In terms of addressing and routing, devices in a P2P group utilize unique identifiers such as MAC addresses to target communications accurately. This ensures that data packets reach their intended destinations without confusion.

While P2P groups operate independently of an AP for data transmission, the role of the AP may still be relevant for initial authentication or resource management, ensuring a smooth and secure communication environment.

P2P communication among Wi-Fi client devices may become one of the most consequential “second networks” in wireless systems. While the infrastructure BSS—an AP coordinating multiple STAs—remains the dominant connectivity model, a huge and growing fraction of real user value comes from device-to-device interactions that either bypass the AP's data plane or use the AP only as a facilitator for discovery, security, and policy. Wi-Fi Direct, Wi-Fi Aware (NAN), TDLS (and more generally “D2D over Wi-Fi” patterns), and various vendor-specific derivatives all exist because they solve a practical problem: the endpoints that want to exchange time-sensitive, high-volume, or context-local data are often in the same room, on the same table, or in the same pocket. Various embodiments of the present disclosure recognize and take into consideration that, in those moments, forcing every byte to go through or hairpin through an AP-possibly across congested uplinks, power-saving schedules, and cloud detours-creates avoidable latency, jitter, and energy waste. P2P is a structural pillar of how users experience collaboration, media, gaming, sensing, and control in homes, offices, factories, vehicles, and public spaces. Because P2P traffic still shares spectrum, time, and interference with the infrastructure BSS (and with neighboring BSSs), the quality users perceive depends critically on how well the infrastructure and P2P networks coordinate their operation.

P2P may be framed not as a replacement for the infrastructure network, but as a complementary connectivity layer optimized for proximity, considering the basic economic reality of radio resources: airtime is the currency, and the medium is shared. When two devices are close, a direct link can often use a higher MCS, fewer retransmissions, and shorter on-air time per bit than an AP-mediated path that might require two separate hops (STA→AP and AP→STA) plus additional contention. This translates into higher effective throughput and lower latency for the same spectral footprint-assuming the link is scheduled and controlled intelligently. P2P also avoids needless backhaul dependency for local interactions, improves privacy for local-only exchanges, and enables resilient operation when WAN access is degraded. These experiences are built atop a mix of discovery mechanisms, security associations, and data paths that frequently rely on Wi-Fi P2P primitives because of their performance and power characteristics.

Various embodiments of the present disclosure recognize and take into consideration that Wi-Fi Direct is a visible example which creates a P2P group where one device becomes a P2P Group Owner (GO), effectively acting like a lightweight AP for the group. This model is used for screen casting, printer access, camera-to-phone transfers, on-site provisioning, and temporary collaboration when an infrastructure network is absent or untrusted. From a system standpoint, the GO role has at least two purposes: making the group manageable using familiar AP/STA semantics, and also concentrating scheduling responsibility and power drain on a battery device. That is why coordination with an infrastructure AP—when available—is useful. If the phone is simultaneously a STA in the infrastructure BSS and a GO for a P2P group, the phone becomes a multi-role device with potentially conflicting timing obligations: beacons, DTIM intervals, power save doze/wake patterns, and EDCA contention all interact. Without careful coordination, one role's latency and reliability can collapse under the other role's duty cycle and contention.

Various embodiments of the present disclosure recognize and take into consideration that Wi-Fi Aware (NAN) addresses a different but equally important dimension: discovery and context. Modern systems increasingly depend on for smart home onboarding, proximity-based sharing, multiplayer gaming lobbies, ad-hoc collaboration, retail experiences, and certain IoT workflows. NAN provides an efficient, low-power framework for devices to publish/subscribe services and discover peers without continuous scanning overhead. But discovery is not independent of QoS; discovery is the first step of a workflow that often escalates quickly into data transfer, session control, and real-time interaction. A device might discover a peer while it is already engaged in infrastructure traffic that is delay-sensitive, such as voice, video conferencing, cloud gaming, or uplink sensor telemetry. If discovery and subsequent P2P session establishment are not coordinated with the infrastructure BSS's scheduling and admission control, the system can suffer: a new P2P session begins, consumes contention opportunities, triggers channel switching or off-channel activity, and suddenly the ongoing infrastructure flows experience jitter and packet loss. In well-designed systems, the AP and devices treat P2P initiation not as an isolated event but as a managed resource allocation decision.

Various embodiments of the present disclosure recognize and take into consideration that tunneled direct link setup (TDLS) is often associated with enabling a direct link between two STAs that are already associated to the same AP, with the AP helping set up the security context and link parameters. Conceptually, TLDS is a clean demonstration of the coordination principle: even if the data path becomes direct, the infrastructure association remains important for authentication, policy enforcement, and overall medium coordination. Although TDLS may lack in some adoption scenarios, the underlying idea remains relevant: the “infrastructure network” is not merely a relay; the infrastructure network is the control plane anchor that can arbitrate coexistence between multiple types of traffic and roles. Many platforms may desire to use “TDLS-like” behaviors under different frameworks, especially in enterprise or specialized deployments, because the performance gains can be significant when two devices are close, but the AP is far or congested.

The use of P2P is important beyond file transfer scenarios. Wireless display, multi-room audio synchronization, camera offload, and collaborative editing all benefit from low-latency, high-throughput local links. Gaming is even more demanding: local multiplayer, spectator streaming, and mixed reality experiences often require tight latency bounds and predictable jitter. In AR/VR and spatial computing, motion-to-photon pipelines can tolerate only small bursts of delay before users perceive nausea or discomfort; local P2P links can reduce end-to-end latency by avoiding unnecessary uplink/downlink contention through the AP and by enabling more direct, higher-rate PHY conditions. In a smart home, smart locks, doorbells, cameras, and hubs frequently use local device-to-device coordination for setup, handoff, and fallback control when cloud connectivity is down. In industrial and healthcare environments, local device swarms-tools, scanners, sensors, displays-need robust, policy-driven interactions that cannot rely on an internet round trip. Vehicles are emerging as major Wi-Fi P2P consumers as well, with in-cabin hotspots, device pairing, keyless entry ecosystems, and sensor-assisted experiences that all can utilize proximity communication and low-latency coordination.

All of those scenarios share a constraint: the radio channel is still shared, and contention-based access is inherently stochastic. P2P sessions overlap with infrastructure sessions, and often occur in exactly the moments when users are already pushing the network-video calls, streaming, cloud sync, and background updates. This is why close coordination between the infrastructure network and the P2P network is important. Close coordination between the infrastructure network and the P2P network is the practical requirement for predictable Quality of Service (QoS). In an unmanaged coexistence model, P2P simply becomes “more contenders,” and the system degrades toward the worst-case behavior of carrier-sense multiple access with collision avoidance (CSMA/CA) under high load: increased collisions, backoff inflation, variable queuing delay, and poor tail latency. Modern use case/experiences demand bounded latency and consistent throughput in environments where the offered load and interference can change abruptly. Coordination is how those demands are reconciled with a shared medium.

Various embodiments of the present disclosure recognize and take into consideration that coordination starts with awareness of roles and traffic classes. When a device is simultaneously a STA in an infrastructure BSS and a participant in a P2P session—whether as a Wi-Fi Direct GO, a P2P client, or a NAN participant—the device has to multiplex its radio time across multiple logical networks. If this multiplexing is left to ad hoc scanning and best-effort contention, QoS will be fragile. A coordinated system, by contrast, treats the device as a multi-link, multi-role actor with explicit time budgets and priorities. Even without introducing new primitives, coordination can leverage existing constructs: aligning service periods, synchronizing wake times, managing off-channel operations, and ensuring that high-priority traffic (voice, control, interactive video) is protected from disruption when P2P sessions start or change state. Importantly, coordination is not just about protecting infrastructure traffic from P2P; it is equally about protecting P2P traffic from the infrastructure BSS when the P2P flow is the one that is latency-critical. In a casting session, the P2P stream might be the dominant user experience, and infrastructure background sync should not be allowed to create stutter.

Various embodiments of the present disclosure recognize and take into consideration that a major coordination challenge is that infrastructure APs and P2P groups can have different beaconing and power-save rhythms. Infrastructure networks typically have established beacon intervals, DTIM periods, and potentially scheduled access mechanisms, while Wi-Fi Direct groups have their own beacon cadence and client power-save behavior. If a dual-role device must maintain synchronization with both, it can end up forced into frequent wakeups, increased overhead, and higher contention, which degrades both battery life and QoS. Coordinated operation aims to reduce this cadence mismatch. Practically, that can mean aligning group beacon timing with infrastructure beacons when feasible, using negotiated absence periods where a device can temporarily prioritize one role without disrupting the other, and ensuring that transitions-such as channel switches or role handoffs-occur at predictable points that minimize collisions and missed delivery opportunities. When coordination is done well, the system behaves more like a scheduled network at the moments that matter, while still retaining the flexibility and interoperability of contention-based access.

Various embodiments of the present disclosure recognize and take into consideration that another coordination dimension is channel and bandwidth selection. P2P technologies often select channels based on discovery outcomes, device capabilities, and regulatory constraints, but in dense environments the “best” channel for P2P may be tightly coupled to the infrastructure channel plan. If the infrastructure BSS is operating on a congested channel, starting a P2P session on that same channel may be convenient but harmful to both flows; starting on a different channel might improve throughput but introduces multi-channel concurrency requirements and potential scanning/off-channel overhead. Good coordination is therefore about system-level optimization: including considerations for where should the P2P session live, how should share airtime with existing infrastructure flows, and how to minimize disruptive channel switching. In enterprise deployments, the AP may have visibility into load and interference and can guide devices toward better choices; in consumer environments, platform-level coordination (between STA and P2P managers) becomes crucial. The end goal is consistent: reduce the probability that P2P initiation causes a sudden QoS collapse for either network.

Various embodiments of the present disclosure recognize and take into consideration that QoS assurance also requires coherent prioritization at the MAC layer. Wi-Fi already has EDCA access categories, and modern implementations map application traffic to these categories to some extent. But when introducing simultaneous infrastructure and P2P operation, simple priority tagging is not enough. A device can prioritize its own outgoing packets, but it cannot directly control the behavior of other contenders, including the AP and other STAs, unless there is a shared coordination framework. This is where close cooperation between the infrastructure AP and P2P roles matters: admission control, airtime fairness policies, and scheduling-like behaviors can be applied with a broader view. If the AP understands that a device is engaged in a P2P session with specific latency requirements, the AP can adjust its own transmission patterns-downlink bursting, trigger-based opportunities, or simply moderating best-effort traffic-so that the combined system maintains acceptable tail latency. Likewise, if the P2P group owner understands the infrastructure's constraints, the P2P group owner can shape its beaconing, service periods, and forwarding behavior to avoid starving infrastructure flows.

Various embodiments of the present disclosure recognize and take into consideration that the need for coordination becomes even more pronounced as users move into “multi-device experiences” and “device clouds.” A phone may be simultaneously connected to a home AP, maintaining a low-latency P2P link to a TV for casting, coordinating with earbuds over a different wireless technology, and participating in discovery for nearby devices. But absent coordination, the system can exhibit pathological interactions: off-channel discovery causing missed beacons, power-save transitions causing bursty latency, P2P group maintenance causing periodic contention spikes, and uplink congestion causing downlink stalls. In other words, P2P and infrastructure operation can create each other's worst-case behavior unless the control plane explicitly manages concurrency.

Various embodiments of the present disclosure recognize and take into consideration that, from a broader technology perspective, P2P is also a foundational enabler for edge intelligence and distributed sensing. Devices increasingly collaborate: cameras and phones performing joint capture, phones and laptops co-processing AI workloads, wearables streaming sensor data to a nearby hub for inference, and home devices coordinating automations without cloud round trips. Coordination between infrastructure and P2P networks is what allows these edge workflows to coexist with traditional internet traffic. Coordination between infrastructure and P2P networks is also what allows security and policy to remain coherent. Infrastructure APs often represent the policy boundary for a home or enterprise network: authentication, authorization, and device onboarding policies live there. If P2P sessions form and exchange data outside that boundary without coordination, administrators lose visibility and control, and users can encounter inconsistent security experiences. A coordinated design can keep P2P efficient while still respecting the infrastructure's policy intent.

Various embodiments of the present disclosure recognize and take into consideration that TXOP Sharing for P2P group (TXSPG) is an important feature for IEEE 802.11bn (Wi-Fi) and that the AP's behavior for TXOP sharing is not clear and needs to be clarified. Accordingly, various embodiments of the present disclosure provide a mechanism for TXOP provisioning by the AP for TXSPG procedure. Various embodiments of the present disclosure further provide procedure and frame exchanges using which the AP can allocate a TXOP to a P2P group. Various embodiments of the present disclosure further provide AP's behavior during the time allocated to the P2P group. Various embodiments of the present disclosure further provide a set of exception rules to allow AP's transmission during the allocated time.

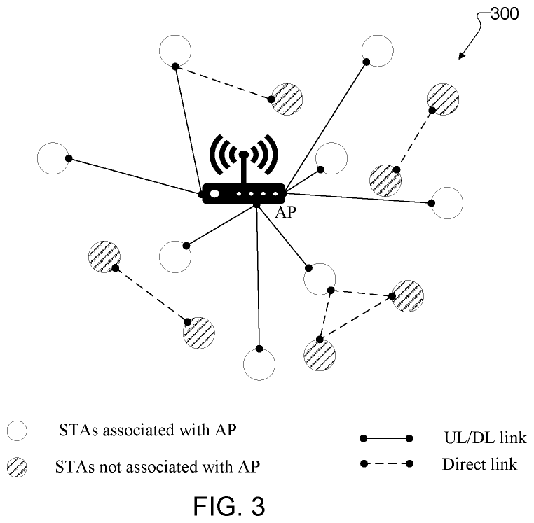

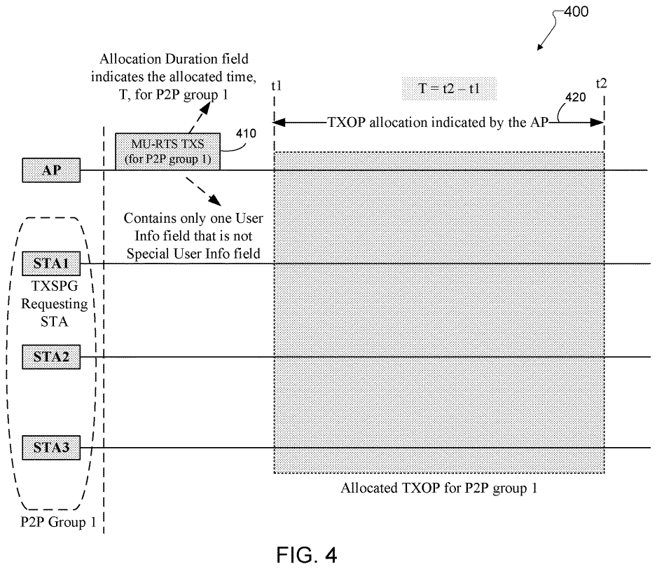

FIG. 4 illustrates an example frame sequence 400 for TXOP allocation for P2P group according to embodiments of the present disclosure. FIG. 5 illustrates an example method 500 for TXOP allocation for a P2P group according to embodiments of the present disclosure. The sequence 400 of FIG. 4 can be performed between any one of the APs 101-103 of FIG. 1, such as AP 101 of FIG. 2A and any of the STAs 111-114 of FIG. 1, such as the STA 111 of FIG. 2B. The method 500 of FIG. 5 can be performed by any of the APs 101-103 of FIG. 1, such as AP 101 of FIG. 2A, and a corresponding method can be performed by any of the STAs 111-114 of FIG. 1, such as the STA 111 of FIG. 2B. The sequence 400 and the method 500 are for illustration only and other embodiments can be used without departing from the scope of the present disclosure.

In various embodiments, an ultra-high reliability (UHR) AP may allocate time within an obtained TXOP to a P2P group by transmitting an MU-RTS TXS trigger frame. For example, the MU-RTS TXS trigger frame may be parameterized to include one or more of the following:
The TXS Mode subfield of the Common Info field is set to 3.
The MU-RTS TXS Trigger frame shall have only one User Info field that is not a Special User Info field.
The User Info field shall be addressed to an associated TXSPG Requesting STA (i.e., Association Identifier (AID) 12 subfield is set to a value in the range 1 to 2006) that requested TXOP sharing for the P2P group.
The P2P Group ID subfield of the User Info field shall be set to the P2P group ID of the P2P group.

The time allocated to the associated non-AP EHT STA or to the P2P group is specified in the allocation duration subfield in the MU-RTS TXS Trigger frame. Examples of these above embodiments are illustrated using frame exchange sequence in FIG. 4. The AP transmits a MU-RTS TXS trigger frame 410 for P2P group 1 which includes an allocation duration field that indicates the allocated time T for P2P group 1. The TXOP allocation indicated by the AP is denoted 420 in FIG. 4. The MU-RTS TXS trigger frame 410 contains only one User Info field that is not Special User Info field.

In FIG. 5, for a UHR AP that supports TXSPG operation, the UHR AP sends an MU-RTS TXS trigger frame to a P2P group to allocate a portion of its TXOP of length, T, to the P2P group (510). The UHR AP sends an MU-RTS TXS trigger frame addressed to the P2P group (520). In the transmitted MU-RTS TXS trigger frame, the UHR AP includes only one User Info field that is not a Special User Info field (530). In the transmitted MU-RTS TXS trigger frame, the length of the TXOP, T, that is to be allocated to the P2P group is indicated in the Allocation Duration field of the MU-RTS TXS Trigger frame (540).

In various embodiments, if the UHR AP determines that its transmission of an MU-RTS TXS Trigger frame with the TXS Mode subfield equal to 3 is successful, then the AP shall not transmit any physical layer protocol data unit (PPDU) within the allocated time specified in the MU-RTS TXS Trigger frame unless one of the following conditions are true:
The PPDU carries an immediate response that is solicited by the non-AP STA.
The AP with the TXOP Return Support In TXSPG subfield equal to 1 received a frame from a TXSPG Requesting STA in the P2P group containing a CAS Control field with the RDG/More PPDU subfield equal to 0, in which case the AP may transmit a PPDU SIFS after the frame with a CAS Control field.

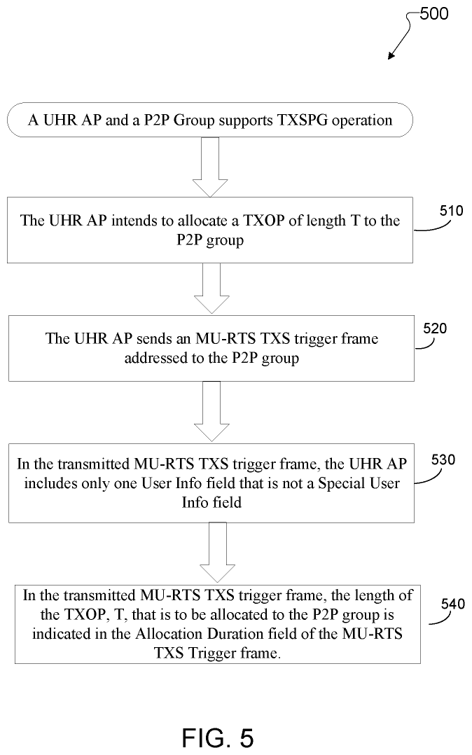

FIG. 6 illustrates an example frame sequence 600 for successful transmission of MU-RTS TXS trigger frame according to embodiments of the present disclosure. The sequence 600 of FIG. 6 can be performed between any one of the APs 101-103 of FIG. 1, such as AP 101 of FIG. 2A and any of the STAs 111-114 of FIG. 1, such as the STA 111 of FIG. 2B. The sequence 600 is for illustration only and other embodiments can be used without departing from the scope of the present disclosure.

As illustrated in FIG. 6, according to one embodiment, when the UHR AP sends the MU-RTS TXS trigger frame 410 for the P2P group, if the UHR AP receives a message 630, in response, from the TXSPG Requesting STA indicating that the P2P group has received the MU-RTS TXS trigger frame 410, then the UHR AP can determine that the transmission of the MU-RTS TXS trigger frame 410 for the P2P group is successful. This message 630 can be an Acknowledgement frame in response to the MU-RTS TXS trigger frame 410. Alternatively, this message can be a Block Acknowledgement frame in response to the MU-RTS TXS trigger frame 410. Alternatively, this message can be a CTS frame in response to the MU-RTS TXS trigger frame 410.

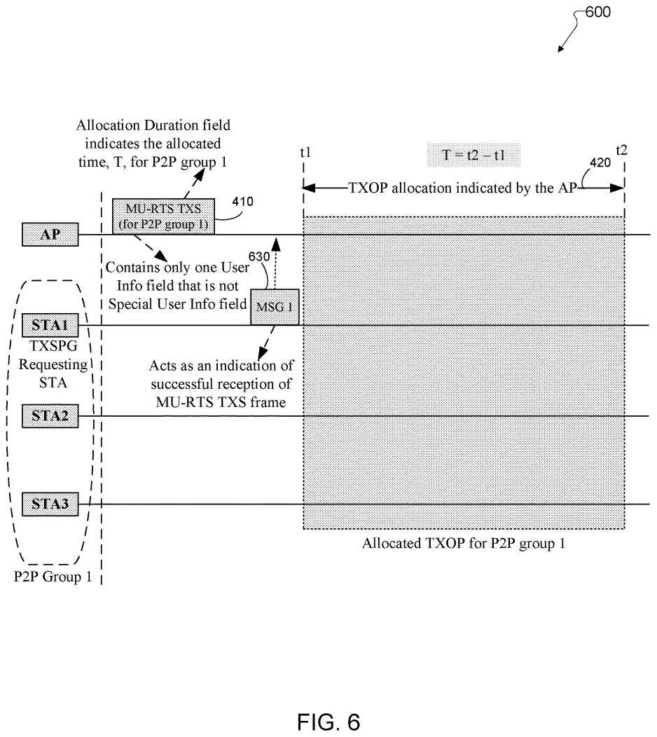

FIG. 7 illustrates an example frame sequence 700 for a UHR AP's transmission exception rule during the allocated TXOP to the P2P group due to solicited immediate response according to embodiments of the present disclosure. The sequence 700 of FIG. 7 can be performed between any one of the APs 101-103 of FIG. 1, such as AP 101 of FIG. 2A and any of the STAs 111-114 of FIG. 1, such as the STA 111 of FIG. 2B. The sequence 700 is for illustration only and other embodiments can be used without departing from the scope of the present disclosure.

As illustrated in FIG. 7, during the allocated TXOP for the P2P group, STA1 sends PPDU 1 740 to the UHR AP, PPDU 1 740 solicits immediate response from the AP. As a result, the UHR AP is allowed to send a PPDU (PPDU 2) 750 during that allocated time, where PPDU 2 750 carries the immediate response solicited by PPDU 1.

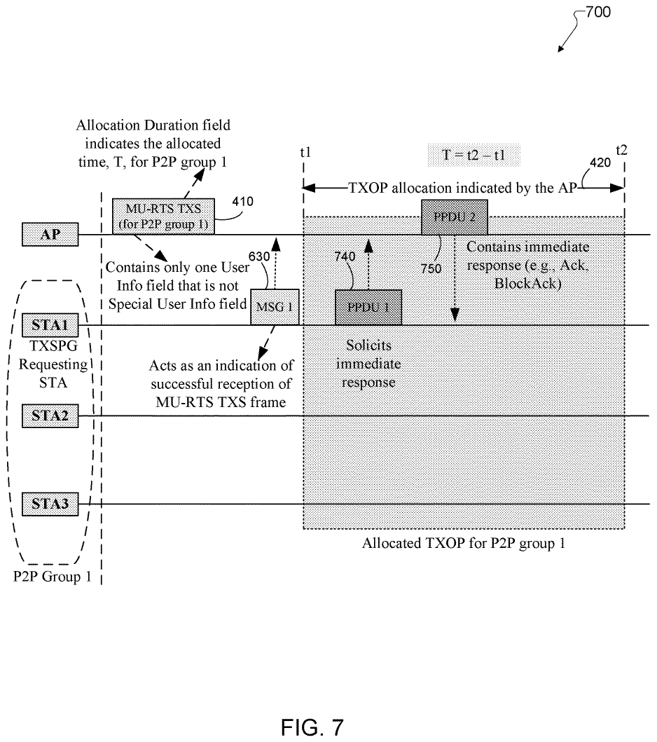

FIG. 8 illustrates an example frame sequence 800 for a UHR AP's transmission exception rule during the allocated TXOP to the P2P group due to reception of a CAS Control field according to embodiments of the present disclosure. The sequence 800 of FIG. 8 can be performed between any one of the APs 101-103 of FIG. 1, such as AP 101 of FIG. 2A and any of the STAs 111-114 of FIG. 1, such as the STA 111 of FIG. 2B. The sequence 800 is for illustration only and other embodiments can be used without departing from the scope of the present disclosure.

As illustrated in FIG. 8, during the allocated TXOP for the P2P group 420, STA1 sends PPDU 1 840 to the UHR AP, PPDU 1 840 carries a command and status (CAS) Control field with reverse direction grant (RDG)/more PPDU field equal to 0. As a result, the UHR AP is allowed to send a PPDU (PPDU 2) 850 during that allocated time (after a short interframe spacing (SIFS) duration), where PPDU 2 850 carries a CAS control field.

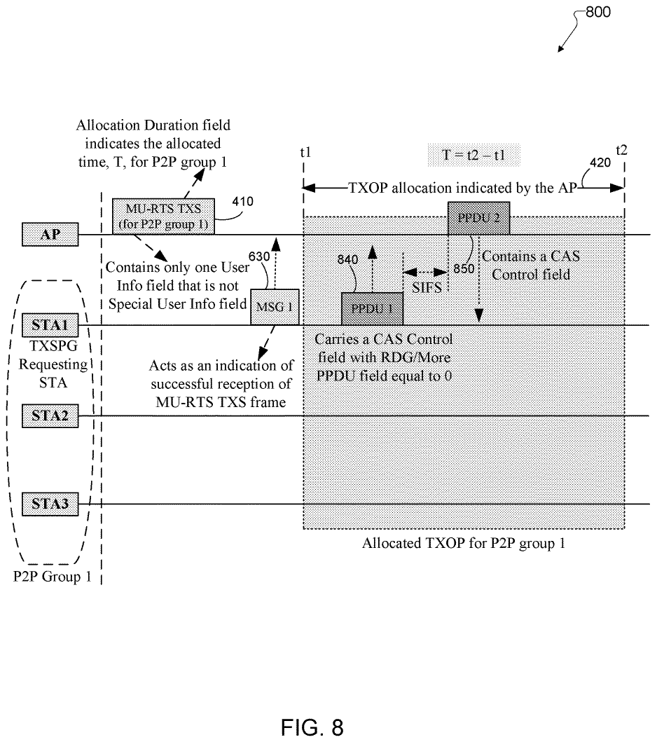

FIG. 9 illustrates an example method 900 for a UHR AP's transmission exception rule during the allocated TXOP to the P2P group according to embodiments of the present disclosure. The method 900 of FIG. 9 can be performed by any of the APs 101-103 of FIG. 1, such as AP 101 of FIG. 2A, and a corresponding method can be performed by any of the STAs 111-114 of FIG. 1, such as the STA 111 of FIG. 2B. The method 900 is for illustration only and other embodiments can be used without departing from the scope of the present disclosure.

For a UHR AP that supports TXSPG operation, the UHR AP sends an MU-RTS TXS trigger frame to a P2P group to allocate a portion of its TXOP of length, T, to the P2P group (910). The UHR AP receives a message (e.g., Ack, BA, or RTS) from the P2P group (from TXSPG requesting STA of the P2P group) indicating that the transmission of the MU-RTS TXS trigger frame by the UHR AP is successful (920).

The AP determines whether it receive a frame from the TXSPG requesting STA during the allocated time T (930). If no, the UHR AP does not transmit any PPDU during the time, T, allocated to the P2P group (940). If yes, the AP determines whether the received frame solicits an immediate response from the UHR AP (950). If yes, the UHR AP may transmit a PPDU during the allocated time T, where the PPDU contains the solicited immediate response (960). If no, the AP determines whether the received frame contains a CAS Control field with RDG/More PPDU field equal to 0 (970). If yes, the UHR AP may transmit a PPDU during the allocated time T, a SIFS after the received frame, where the PPDU contain a CAS Control field (980). If no, the UHR AP does not transmit any PPDU during the time, T, allocated to the P2P group (990).

In various embodiments, a UHR AP may not send an MU-RTS TXS Trigger frame with TXS Mode subfield equal to 3 and with the User Info field that is addressed to an associated non-AP STA from which it has not received a UHR Capabilities element with the TXSPG Support subfield equal to 1.

Various embodiments provide signaling for TXOP provisioning in TXSPG. For example, a protected UHR action field, in the octet immediately after the Category field, differentiates the Protected UHR Action frame formats. The Protected UHR Action field values associated with each frame format within the UHR category are defined in Table 1 below (Protected UHR Action field values).

TABLE 1
Protected UHR Action field values

| Value | Meaning | Time priority |
|---|---|---|
| 0 | TXSPG Provisioning | No |
| 1 | TXSPG Provisioning Response | No |
| 2-255 | | |

The Action field of the TXSPG Provisioning frame contains the information shown in Table 2 below (TXSPG Provisioning frame Action field format).

TABLE 2
TXSPG Provisioning frame Action field format

| Order | Information |
|---|---|
| 1 | Category |
| 2 | Protected UHR Action |
| 3 | Dialog Token |
| 4 | P2P element (see 9.4.2.xx (P2P element)) |
| 5 | QoS Characteristics element (Optional) |

The Dialog Token field is defined in 9.4.1.12 of [1] (Dialog Token field). The Dialog Token field is set to a nonzero value chosen by the AP sending the TXSPG Provisioning frame to identify the TXSPG Provisioning/TXSPG Provisioning Response frames transaction.

The Action field of the TXSPG Provisioning Response frame contains the information shown in Table 3 below (TXSPG Provisioning Response frame Action field format).

TABLE 3
TXSPG Provisioning Response frame Action field format

| Order | Information |
|---|---|
| 1 | Category |
| 2 | Protected UHR Action |
| 3 | Dialog Token |
| 4 | Status Code |

The Dialog Token field is defined in 9.4.1.12 of [1] (Dialog Token field). The Dialog Token field is set to a nonzero value chosen by the non-AP STA sending the TXSPG Provisioning Response frame to identify the TXSPG Provisioning/TXSPG Provisioning Response frames transaction.

The Status Code field is defined in 9.4.1.9 of [1] (Status Code field) and is set to the value 0 (SUCCESS) or 141 (DENIED_TXSPG_PROVISIONING).

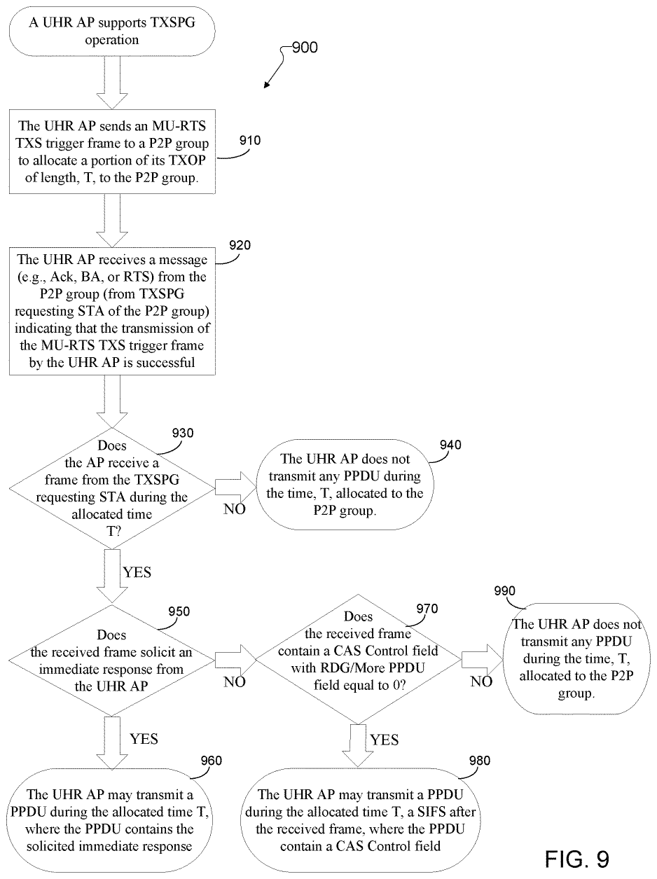

FIG. 10A illustrates an example of format of a P2P element 1000 according to embodiments of the present disclosure. The embodiment of the format of a P2P element 1000 shown in FIG. 10A is for illustration only. Other embodiments could be used without departing from the scope of this disclosure.

As shown in FIG. 10A, the P2P element 1000 includes Element ID, Length, and Element ID Extension fields as defined in 9.4.2.1 of [1] (General). The control field format is shown in FIG. 10B

FIG. 10B illustrates an example of control field format 1020 according to embodiments of the present disclosure. The embodiment of the control field format 1020 shown in FIG. 10B is for illustration only. Other embodiments could be used without departing from the scope of this disclosure.

As shown in FIG. 10B, the control field format 1020 includes a Group Negotiating STA AID12 Present subfield that indicates the presence of the Group Negotiating STA AID12 field in the P2P element. If the Group Negotiating STA AID12 Present subfield in the Control Info field is set to 1, then the Group Negotiating STA AID12 field is present in the P2P element; otherwise, the field is not present.

The Group Negotiating STA MAC Address Present subfield indicates the presence of the Group Negotiating STA MAC Address field in the P2P element. If the Group Negotiating STA MAC Address Present subfield in the Control Info field is set to 1, then the Group Negotiating STA MAC Address field is present in the P2P element; otherwise, the field is not present.

FIG. 10C illustrates an example of P2P Group Info field format 1040 according to embodiments of the present disclosure. The embodiment of the P2P Group Info field format 1040 shown in FIG. 10C is for illustration only. Other embodiments could be used without departing from the scope of this disclosure.

As shown in FIG. 10C, the P2P Group Info field format 1040 includes a P2P Group ID subfield in the P2P Group Info field that indicates the P2P group ID assigned by the AP for the P2P group whose information is carried by the P2P element.

The Group Negotiating STA AID12 field, if present, indicates the AID12 value of the non-AP STA that performed the TXSPG negotiation with the AP for the P2P group identified by the P2P Group ID subfield.

The Group Negotiating STA MAC Address field, if present, indicates the MAC Address of the non-AP STA that performed the TXSPG negotiation with the AP for the P2P group identified by the P2P Group ID subfield.

Table 4 below provides definitions for values that may be included in the TXS Mode subfield in the MU-RTS Trigger frame format discussed in various embodiments herein.

TABLE 4
TXS Mode subfield encoding

| TXS Mode | |
|---|---|
| subfield value | Description |
| 0 | MU-RTS that does not initiate TXS procedure. |
| 1 | MU-RTS that initiates TXS procedure wherein a scheduled |
| | STA can only transmit MPDU(s) addressed to its associated AP. |
| 2 | MU-RTS that initiates TXS procedure wherein a scheduled |
| | STA can transmit MPDU(s) addressed to its associated AP |
| | or addressed to another STA. |
| 3 | MU-RTS that initiates TXS procedure for a scheduled P2P |
| | group, wherein a non-AP STA member of the addressed P2P |
| | group can transmit MPDU(s) to another non-AP STA member of |
| | the same P2P group. |

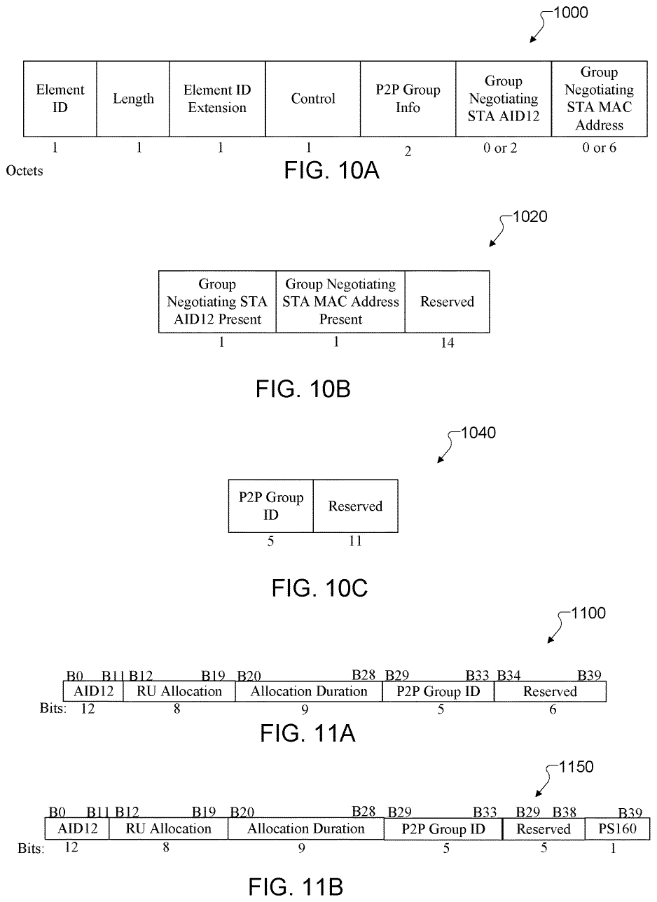

FIG. 11A illustrates an example of HE variant User Info field format 1100 in the MU-RTS TXS Trigger frame according to embodiments of the present disclosure. FIG. 11B illustrates an example of EHT variant User Info field 1150 of MU-RTS TXS Trigger frame according to embodiments of the present disclosure. The embodiment of the formats of the HE variant User Info field format 1100 and EHT variant User Info field 1150 shown in FIGS. 11A-11B are for illustration only. Other embodiments could be used without departing from the scope of this disclosure.

According to one embodiment, a UHR AP that has successfully obtained a TXOP may facilitate communication within a P2P group to which one of its associated non-AP STAs belongs. To achieve this, the UHR AP can transmit a MU-RTS Transmission Sequence (TXS) trigger frame. The configuration of this trigger frame is crucial for correctly indicating the AP's intent to allocate a portion of its TXOP for P2P group activities. Specifically, the TXS Mode subfield within the Common Info field of this MU-RTS TXS trigger frame shall be explicitly set to a value of 3. This particular setting signals that the subsequent transmission will follow a transmission sequence initiated by the trigger frame, allowing for coordinated access within the allocated time.

According to one embodiment, to maintain clarity and avoid unintended triggering of multiple STAs for uplink transmissions not related to the P2P group, the MU-RTS TXS Trigger frame, when intended for P2P TXOP sharing, shall contain exactly one User Info field that is not designated as a Special User Info field. This single User Info field will carry the necessary addressing and allocation information for the specific TXSPG Requesting STA that initially requested the TXOP sharing on behalf of its P2P group. By limiting the User Info fields in this manner, the UHR AP ensures that only the intended requesting STA is triggered to manage the subsequent P2P communication within the allocated TXOP.

According to one embodiment, the sole non-Special User Info field within the MU-RTS TXS Trigger frame must be directly addressed to the associated TXSPG Requesting STA. This addressing is achieved by setting the AID12 subfield of the User Info field to the AID value that the UHR AP has assigned to the TXSPG Requesting STA during the association process. This AID value will fall within the standard range of 1 to 2006 for associated non-AP STAs. This explicit addressing ensures that the trigger frame is specifically intended for and processed by the non-AP STA that initiated the TXOP sharing request for its P2P group.

According to one embodiment, to clearly identify the intended P2P group for which the TXOP sharing is being facilitated, the P2P Group ID subfield within the User Info field of the MU-RTS TXS Trigger frame shall be set to the unique identifier of that specific P2P group. This P2P Group ID allows the TXSPG Requesting STA to understand which of its P2P groups is being granted access to the shared TXOP, especially if the STA is a member of multiple P2P groups. This identification mechanism is essential for the requesting STA to correctly coordinate the subsequent communication among the members of the specified P2P group within the allocated time.

According to one embodiment, the duration of the time allocated by the UHR AP to the associated non-AP TXSPG Requesting STA for P2P group activities within the AP's TXOP is precisely specified in the Allocation Duration subfield of the MU-RTS TXS Trigger frame. This subfield indicates the length of the time window granted for the P2P group to exchange data. The value in this subfield would be determined by the UHR AP based on factors such as the initial request from the TXSPG Requesting STA, the AP's available resources, and its policies regarding TXOP sharing. The allocated duration must be sufficient for the P2P group to conduct meaningful communication while also ensuring that the AP can resume its regular service to other associated STAs within a reasonable timeframe.

According to one embodiment, upon receiving the MU-RTS TXS Trigger frame configured as described, the TXSPG Requesting STA is expected to manage the allocated TXOP for communication among the members of its indicated P2P group. This might involve the requesting STA acting as a coordinator, potentially sending further trigger frames or control frames within the allocated duration to other P2P group members to facilitate uplink or downlink data exchange. The specific protocols and frame exchange sequences used within this shared TXOP for P2P communication would be governed by the agreements and capabilities of the P2P group members, potentially leveraging mechanisms from specifications like Wi-Fi Direct for managing group communication.

According to one embodiment, variations of this mechanism could include the UHR AP allocating the TXOP in recurring slots if the TXSPG Requesting STA indicates a periodic need for P2P communication. In such a case, the AP might include information about the recurring schedule in a response to the initial request or through subsequent management frames. Furthermore, the UHR AP could potentially indicate the specific Resource Units (RUs) within its TXOP that the P2P group is allowed to use, providing finer-grained control over the shared resources and potentially enabling spatial reuse for the AP's own transmissions on other RUs.

According to one embodiment, a UHR AP may allocate time within an obtained TXOP to a P2P group by transmitting an MU-RTS TXS trigger frame. The TXS Mode subfield of the Common Info field is set to 3, indicating that this frame is used for triggering uplink or P2P transmissions from multiple stations in a P2P group. The MU-RTS TXS Trigger frame includes only one User Info field, which is not a Special User Info field, ensuring that the trigger is specifically addressed to an associated TXSPG Requesting STA. This STA has requested TXOP sharing for the P2P group and is identified by its AID12 subfield value, which falls within the range of 1 to 2006. The P2P Group ID subfield in the User Info field is set to the unique identifier of the P2P group, allowing the associated STA to recognize the allocation. The Allocation Duration subfield specifies the exact time allocated for the P2P group's transmission, ensuring efficient use of the shared TXOP.

According to another embodiment, the UHR AP may further include additional parameters in the MU-RTS TXS Trigger frame to enhance flexibility and efficiency. For instance, the frame may include a Traffic Type subfield indicating whether the allocation is for voice, video, or best-effort traffic, enabling prioritization of latency-sensitive applications. Additionally, the Allocation Duration subfield can be dynamically adjusted based on the current network load or channel conditions, ensuring optimal resource utilization. The UHR AP may also transmit multiple MU-RTS TXS Trigger frames within a single TXOP to accommodate multiple P2P groups, each with its own allocation duration and traffic type parameters. This approach allows for better multitasking and supports diverse use cases within the same network.

According to another embodiment, the UHR AP may implement error handling mechanisms when transmitting the MU-RTS TXS Trigger frame. If the TXSPG Requesting STA fails to decode the trigger frame correctly, it can send a negative acknowledgment (NACK) to the UHR AP. Upon receiving a NACK, the UHR AP may retransmit the MU-RTS TXS Trigger frame with adjusted parameters, such as increasing the transmission power or changing the modulation and coding scheme (MCS). Alternatively, the UHR AP can allocate additional time within the TXOP for retransmission attempts, ensuring that the P2P group's transmissions are not disrupted due to frame errors. This robust error handling mechanism improves reliability in noisy wireless environments.

According to another embodiment, the MU-RTS TXS Trigger frame may support multiple User Info fields, each addressed to different associated TXSPG Requesting STAs within the same P2P group. Each User Info field includes a unique AID12 subfield value and a common P2P Group ID subfield, allowing multiple stations in the group to transmit during the allocated time. The Allocation Duration subfield is set to the same value for all User Info fields, ensuring that all members of the P2P group have synchronized transmission opportunities. This feature enhances efficiency by enabling simultaneous uplink transmissions from multiple devices within the group, while maintaining coordination through the UHR AP.

According to another embodiment, the UHR AP may dynamically adjust the allocation duration based on feedback received from the associated TXSPG Requesting STA. For example, after transmitting the MU-RTS TXS Trigger frame, the STA can send a feedback frame indicating its remaining buffer size or changes in application requirements. The UHR AP then adjusts the Allocation Duration subfield in subsequent trigger frames to match the actual needs of the P2P group, preventing underutilization or overflow of the allocated time. This adaptive allocation mechanism ensures that resources are used efficiently and aligns with the dynamic nature of wireless communication demands.

According to another embodiment, the MU-RTS TXS Trigger frame may include additional scheduling parameters to support advanced uplink coordination. For instance, the frame can specify a set of orthogonal frequency division multiplexing (OFDM) subchannels or resource blocks allocated for transmission by the P2P group. This allows the associated TXSPG Requesting STA to schedule its uplink transmissions on specific parts of the channel, reducing interference and improving overall network performance. The UHR AP can also rotate or adjust these allocations across different TXOP periods to ensure fair access and balance among multiple P2P groups sharing the same network.

According to another embodiment, the UHR AP may integrate security features into the MU-RTS TXS Trigger frame to protect sensitive information. For example, the Allocation Duration subfield and other parameters can be encrypted using a group-specific key shared among members of the P2P group. This prevents unauthorized devices from decoding the trigger frame and accessing the allocated transmission opportunities. Additionally, the UHR AP can include an integrity check value (ICV) or message authentication code (MAC) in the frame to ensure its authenticity and prevent tampering by malicious entities.

According to another embodiment, the MU-RTS TXS Trigger frame may be used in conjunction with uplink multi-user multiple-input multiple-output (MU-MIMO) techniques. The UHR AP can allocate distinct spatial streams or beamforming weights to each member of the P2P group based on their channel conditions and transmission requirements. This enables simultaneous transmissions from multiple devices while maintaining high throughput and spectral efficiency. The Allocation Duration subfield is adjusted to account for the additional processing time required for MU-MIMO operations, ensuring that all participants have sufficient time for their scheduled transmissions.

According to another embodiment, the UHR AP may support hybrid networks by allowing the MU-RTS TXS Trigger frame to be compatible with both legacy and next-generation devices. For backward compatibility, the frame can include a fallback mode where the Allocation Duration subfield is interpreted according to older standards, while still providing enhanced functionality for newer devices. This ensures seamless operation in mixed-device environments, making the technology more versatile and widely adoptable without sacrificing performance.

According to another embodiment, the UHR AP may implement a priority-based allocation mechanism using the MU-RTS TXS Trigger frame. For example, P2P groups with higher-priority traffic, such as real-time video conferencing or online gaming, can be allocated longer durations in the Allocation Duration subfield compared to lower-priority groups. This prioritization is communicated through the TXS Mode subfield, allowing associated STAs to adjust their transmission scheduling accordingly. The UHR AP continuously monitors network conditions and dynamically adjusts these priorities to maintain optimal performance across all connected devices.

According to another embodiment, the MU-RTS TXS Trigger frame may be utilized in conjunction with enhanced quality of service (QoS) mechanisms. The UHR AP can assign different QoS levels to P2P groups based on their application requirements, and reflect this in the Allocation Duration subfield. For instance, a group requiring low-latency communication for virtual reality applications can receive shorter but more frequent allocations, while a group focused on file transfers might receive longer but less frequent allocations. This QoS-aware scheduling ensures that each P2P group's needs are met without compromising overall network efficiency.

According to another embodiment, the UHR AP may leverage machine learning algorithms to optimize the allocation of TXOP time using insights from historical transmission data. By analyzing patterns in the usage of allocated durations by different P2P groups, the UHR AP can predict future demands and adjust the Allocation Duration subfield accordingly. This predictive scheduling minimizes wasted resources and ensures that each group receives exactly the amount of time it needs, leading to improved user satisfaction and network performance.

According to another embodiment, the MU-RTS TXS Trigger frame may include a new field indicating the maximum number of retransmissions allowed for uplink transmissions within the allocated duration. This allows associated STAs to manage their transmission strategies more effectively, balancing reliability with resource efficiency. If a STA exceeds the allowed retransmissions without successful delivery, it can request an extension of the allocation duration or adjust its MCS to improve transmission success rates in subsequent attempts.

According to another embodiment, the UHR AP may extend the functionality of the MU-RTS TXS Trigger frame to support multi-channel operations. For example, the frame can specify which channels or channel bonding configurations are available for uplink transmissions by the P2P group. This enables devices to utilize broader bandwidths when available, enhancing throughput and reducing congestion on individual channels. The Allocation Duration subfield is then adjusted to account for the increased capacity provided by multi-channel operations.

According to another embodiment, the MU-RTS TXS Trigger frame may be integrated with advanced power-saving mechanisms. For instance, the UHR AP can indicate in the frame whether a low-power mode is enabled for the P2P group, allowing associated STAs to enter a reduced power state during inactive periods within the allocated duration. This not only conserves battery life on mobile devices but also reduces overall network energy consumption without impacting performance.

According to another embodiment, the UHR AP may use the MU-RTS TXS Trigger frame to enable time-shared uplink and downlink transmissions within the same TXOP period. The Allocation Duration subfield can specify separate intervals for uplink and downlink activities, allowing the P2P group to efficiently manage bidirectional communication without conflicts. This approach is particularly beneficial in scenarios where both upstream and downstream data need to be transmitted in a coordinated manner.

According to another embodiment, the UHR AP may introduce a mechanism for overlapping allocations using the MU-RTS TXS Trigger frame. For example, multiple P2P groups can share the same TXOP period with their own distinct allocation durations, provided their transmissions do not interfere with each other. The UHR AP ensures this by carefully scheduling non-overlapping intervals or assigning different spatial streams to each group. This overlapping allocation maximizes resource utilization while maintaining performance for all participants.

According to another embodiment, the MU-RTS TXS Trigger frame may be augmented with link adaptation parameters tailored to each P2P group member. For instance, the UHR AP can include MCS recommendations or channel state information (CSI) feedback in the frame, helping associated STAs optimize their transmission settings for current channel conditions. This personalized link adaptation ensures that each device within the P2P group achieves the best possible performance during its allocated time.

According to another embodiment, the UHR AP may implement a hierarchical scheduling architecture using the MU-RTS TXS Trigger frame. In this model, higher-priority P2P groups receive their allocations first, and any remaining TXOP time is allocated to lower-priority groups. The Allocation Duration subfield reflects this hierarchy, ensuring that critical applications have sufficient transmission opportunities while less urgent traffic utilizes available resources efficiently.

According to another embodiment, the MU-RTS TXS Trigger frame may support distributed coordination among multiple UHR APs in a mesh network. Each AP can share allocation information with neighboring APs, allowing them to synchronize their TXOP allocations for P2P groups that span across different coverage areas. This coordinated approach minimizes interference and ensures seamless communication for devices moving between different access points within the mesh.

According to another embodiment, the UHR AP may integrate the MU-RTS TXS Trigger frame with network slicing techniques. Each P2P group can be assigned to a specific network slice with its own performance characteristics, such as ultra-reliable low-latency communication (URLLC) or enhanced mobile broadband (eMBB). The Allocation Duration subfield is then optimized based on the requirements of the assigned network slice, providing tailored service levels for each group.

According to another embodiment, the MU-RTS TXS Trigger frame may be used in conjunction with edge computing applications. By allocating specific durations for uplink transmissions from P2P groups engaged in edge computing tasks, such as real-time data processing or AI inference, the UHR AP ensures low-latency and high-throughput communication between devices and edge servers. This is particularly beneficial for delay-sensitive applications that rely on rapid data transfer and processing.

According to another embodiment, the UHR AP may introduce a mechanism for adaptive modulation of the Allocation Duration subfield based on device mobility. For example, if a member of the P2P group is detected to be moving at high speed, the UHR AP can reduce the allocation duration to account for potential handovers or changes in channel conditions. This proactive adjustment ensures stable performance even as devices move within or between coverage areas.

According to another embodiment, the MU-RTS TXS Trigger frame may include a field indicating the preferred transmission direction (uplink or downlink) for the P2P group during the allocated duration. This allows associated STAs to prioritize their data transmission in the specified direction, reducing contention and improving overall efficiency. The UHR AP can dynamically switch the preferred direction based on network demands or application requirements.

According to another embodiment, the UHR AP may support multi-hop transmissions within the P2P group using the MU-RTS TXS Trigger frame. For example, if a device in the group is out of direct range from the UHR AP, it can relay its data through other group members during their allocated transmission times. The Allocation Duration subfield accounts for the additional latency introduced by multi-hop paths, ensuring that all devices have sufficient time to transmit their data successfully.

According to another embodiment, the MU-RTS TXS Trigger frame may be used in conjunction with network function virtualization (NFV) to enable flexible allocation of TXOP resources. The UHR AP can dynamically assign virtual network functions (VNFs) to different P2P groups based on their specific needs, optimizing resource utilization and service delivery. This integration allows for a more scalable and adaptable network architecture that can evolve with changing demands.

According to another embodiment, the UHR AP may implement a load balancing mechanism using insights from the MU-RTS TXS Trigger frame. By monitoring the allocation durations and usage patterns of different P2P groups, the UHR AP can redistribute TXOP resources to balance the network load and prevent congestion hotspots. This ensures that all connected devices experience consistent performance regardless of varying demand levels.

According to another embodiment, the MU-RTS TXS Trigger frame may include a field specifying the maximum number of simultaneous transmissions allowed within the P2P group during the allocated duration. This allows the UHR AP to enforce limits on concurrency, preventing excessive contention and ensuring that each transmission has sufficient bandwidth and resources for reliable delivery.

According to another embodiment, the UHR AP may enhance the MU-RTS TXS Trigger frame with support for device-specific transmission opportunities. For example, within a P2P group, individual devices can request personalized allocation durations based on their unique application needs or hardware capabilities. The UHR AP aggregates these requests and distributes tailored allocations within the TXOP period, ensuring that each device operates at its maximum efficiency.

According to another embodiment, the MU-RTS TXS Trigger frame may be integrated with advanced interference mitigation techniques. For instance, the UHR AP can allocate specific time slots or subchannels to P2P groups in a way that minimizes interference from neighboring networks or devices. The Allocation Duration subfield is adjusted to account for any additional guard intervals or interference avoidance periods, ensuring uninterrupted communication.

According to another embodiment, the UHR AP may use the MU-RTS TXS Trigger frame to implement a token-based scheduling system. Each P2P group receives tokens representing transmission opportunities, which are redeemed during the allocated duration specified in the Allocation Duration subfield. Tokens can be earned or prioritized based on QoS requirements, ensuring fair and efficient access to shared resources.

According to another embodiment, the MU-RTS TXS Trigger frame may support the allocation of TXOP time for P2P groups operating in both infrastructure and ad-hoc modes. In ad-hoc mode, devices within the P2P group can dynamically negotiate their own transmission schedules without direct AP involvement, using the Allocation Duration subfield as a guideline to avoid conflicts with other groups or networks.

According to one embodiment, a UHR AP is mandated to ascertain the peer STA's capability to support TXSPG before initiating the process via an MU-RTS TXS Trigger frame with the TXS Mode subfield set to 3. This prerequisite ensures that the AP does not attempt to invoke a feature that the recipient non-AP STA is not equipped to handle, preventing potential communication failures or misinterpretations. The UHR AP achieves this verification by examining the UHR Capabilities element transmitted by the associated non-AP STA during the association or a subsequent capability exchange procedure. Within this element, the TXSPG Support subfield, if set to 1, explicitly indicates the STA's readiness to participate in TXOP sharing as a requesting entity for its P2P group.

According to one embodiment, if the UHR AP has not received a UHR Capabilities element from an associated non-AP STA, or if the received element has the TXSPG Support subfield set to 0, then the UHR AP is strictly prohibited from transmitting an MU-RTS TXS Trigger frame with the TXS Mode set to 3 that includes a User Info field addressed to that specific non-AP STA. This restriction is crucial for maintaining the integrity of the wireless network operation, as sending such a trigger frame to an unsupported STA could lead to undefined behavior, such as the STA ignoring the frame, transmitting an unexpected response, or entering an erroneous state. This mechanism ensures that TXOP sharing for P2P groups is only attempted with devices that have explicitly signaled their capability to participate in this advanced feature.

According to one embodiment, as a variation, the UHR AP could maintain a record of the TXSPG Support capability for each associated non-AP STA. This record would be updated whenever a UHR Capabilities element is received from a STA, ensuring that the AP has the most current information regarding each STA's supported features. Before transmitting an MU-RTS TXS Trigger frame for P2P TXOP sharing to a particular STA, the AP would consult this internal record. Only if the record indicates that the STA supports TXSPG would the AP proceed with sending the trigger frame with TXS Mode equal to 3 and the User Info field addressed to that STA. This proactive checking mechanism reinforces the reliability and efficiency of the TXOP sharing process.

According to one embodiment, in scenarios where a non-AP STA associates with a UHR AP and does not initially advertise UHR capabilities (perhaps due to being an older device or having UHR features disabled), the UHR AP will refrain from allocating TXOP for P2P groups to this STA. If, at a later point, the non-AP STA updates its capabilities and includes a UHR Capabilities element with TXSPG Support set to 1 (for example, through a re-association or a capabilities exchange frame), the UHR AP would then be permitted to initiate P2P TXOP sharing for that STA's P2P group by sending the appropriately configured MU-RTS TXS Trigger frame. This dynamic capability management allows for flexibility while still adhering to the fundamental rule of not invoking unsupported features.

According to one embodiment, consider an example where a UHR AP is managing a network with several associated STAs. STA1 advertises UHR capabilities including TXSPG Support during association. STA2, however, does not include a UHR Capabilities element in its association request. If STA1 (acting as a TXSPG Requesting STA) requests TXOP sharing for its P2P group, the UHR AP is permitted to send an MU-RTS TXS Trigger frame (TXS Mode 3) with a User Info field addressed to STA1, setting the P2P Group ID and Allocation Duration as necessary. However, if STA2 were to make a similar request, the UHR AP would not be allowed to send such a trigger frame to STA2, as STA2 has not indicated support for this feature.

According to one embodiment, to provide more robust error handling, if a UHR AP mistakenly sends an MU-RTS TXS Trigger frame (TXS Mode 3) to a non-AP STA that has not advertised TXSPG Support, the receiving STA might choose to ignore the frame. Alternatively, the standard could define a specific negative acknowledgment or error response that the non-compliant STA could transmit back to the AP, alerting the AP to its error. The AP could then log this event and update its internal record for that STA to ensure that such an attempt is not repeated until the STA's capabilities are explicitly updated. This feedback mechanism would contribute to the overall stability and correctness of the UHR network.

According to one embodiment, a further refinement could involve the UHR AP advertising its own capability to support TXOP sharing for P2P groups. This could be included in Beacon frames or Probe Responses, potentially as part of a UHR Operation element or an extended capabilities element. This advertisement would allow non-AP STAs that also support TXSPG to be aware that this feature is available in the BSS. A non-AP STA that intends to request TXOP sharing would then know to ensure it has advertised its TXSPG Support capability to the AP, facilitating a smoother and more predictable TXOP sharing process.

According to one embodiment, the rationale behind the UHR AP's restriction on sending MU-RTS TXS Trigger frames (with TXS Mode 3) to STAs lacking advertised TXSPG support stems from the fundamental principles of efficient wireless communication and protocol adherence. By ensuring that both the AP and the non-AP STA have explicitly indicated their ability to engage in TXOP sharing for P2P groups, the standard minimizes the risk of wasted airtime and processing resources. Sending such a trigger frame to an unsporting STA would likely result in the frame being ignored, thus consuming valuable TXOP duration without achieving the intended P2P communication facilitation.

According to one embodiment, the UHR Capabilities element, which includes the TXSPG Support subfield, serves as a crucial mechanism for a non-AP STA to inform the UHR AP of its advanced functionalities related to ultra-high reliability and enhanced throughput, including the ability to participate in TXOP sharing on behalf of a P2P group. Without this explicit advertisement from the STA, the UHR AP has no reliable way to determine if the STA is equipped to understand and act upon the specific parameters within the MU-RTS TXS Trigger frame configured for P2P TXOP sharing.

According to one embodiment, considering potential variations, the UHR standard might define a specific Management frame or Action frame exchange dedicated to querying and responding about TXSPG Support capabilities after the initial association. For instance, a non-AP STA could send a specific query frame to the UHR AP requesting information about supported TXOP sharing modes, and the AP could respond with its capabilities. Similarly, the AP could proactively query associated STAs about their UHR capabilities if it intends to utilize advanced features like TXOP sharing for P2P groups. However, the baseline requirement remains that the AP should possess explicit knowledge of the STA's TXSPG Support before sending the specific MU-RTS TXS Trigger frame, regardless of how this knowledge is acquired (initial capability exchange or subsequent query/response).

According to one embodiment, the TXS Mode subfield being set to 3 in the Common Info field of the MU-RTS TXS Trigger frame signifies a particular mode of operation intended for a transmission sequence, specifically for allocating time within the AP's TXOP to a P2P group via a requesting STA. If a non-AP STA has not indicated its TXSPG Support, it is highly probable that its firmware and hardware are not designed to correctly interpret the subsequent signaling and time allocation intended for P2P communication. This could lead to unpredictable behavior, including the STA transmitting at inappropriate times, ignoring valid transmissions from other P2P group members, or causing interference with other devices in the network. The rule therefore acts as a safeguard against such disruptive scenarios.

According to one embodiment, an example of the negative consequences of violating this rule would be a UHR AP sending an MU-RTS TXS Trigger frame (TXS Mode 3) to a legacy STA that does not even understand the UHR Capabilities element or the concept of TXOP sharing for P2P groups. Such a STA would likely ignore the trigger frame entirely. Even if the STA happened to process some part of the frame, it would not be able to correctly interpret the P2P Group ID or the intended allocation duration, rendering the AP's transmission futile and wasting valuable TXOP time that could have been used for other network traffic. This highlights the necessity of the capability check before initiating the P2P TXOP sharing procedure.

According to one embodiment, in more advanced implementations, the UHR AP might implement a mechanism to gracefully handle the situation where a STA requests TXOP sharing for a P2P group but has not advertised TXSPG Support. In such a case, the AP could respond to the initial request with a management frame indicating that the requested feature cannot be granted because the STA has not advertised the necessary capabilities. This would provide clear feedback to the requesting STA and prevent it from repeatedly trying to initiate an unsupported procedure. This proactive denial based on capability assessment contributes to a more robust and user-friendly wireless network.

According to one embodiment, the long-term evolution of the UHR standard might introduce more sophisticated mechanisms for dynamic capability negotiation or feature discovery. However, the fundamental principle of not attempting to use features that a peer device has not indicated support for will likely remain a cornerstone. The specific rule prohibiting the transmission of an MU-RTS TXS Trigger frame (TXS Mode 3) to non-TXSPG-supporting STAs is a direct manifestation of this principle, ensuring a stable and predictable operational environment for ultra-high reliability wireless local area networks. This foundational check prevents unnecessary signaling overhead and potential communication breakdowns.

According to one embodiment, the UHR AP may implement a buffering mechanism for MU-RTS TXS Trigger frames when the target STA lacks the necessary capabilities. This mechanism could temporarily store frames until the AP receives confirmation of TXSPG support from the STA. During this period, the AP might utilize alternative trigger frames compatible with the STA's known capabilities to maintain efficient communication without violating the constraints.

According to another embodiment, the UHR AP could dynamically adjust its transmission strategy based on the STA's capabilities. If a STA doesn't support TXS Mode 3, the AP might switch to a different mode or use a fallback mechanism, ensuring that data transmission continues uninterrupted. This adaptability would be crucial in mixed environments with both advanced and legacy devices.

According to another idea, the UHR AP might maintain a database of associated STAs, tracking their specific capabilities to inform its frame transmission decisions. This database could be updated dynamically as STAs join or leave the network, allowing the AP to efficiently manage which frames are sent to each device without unnecessary overhead.

According to yet another embodiment, the AP could employ polling mechanisms to check for capability updates from connected STAs periodically. This proactive approach ensures that any changes in STA capabilities are quickly identified and incorporated into the AP's transmission strategies, enhancing overall network flexibility and performance.

In scenarios involving legacy devices, according to one embodiment, the UHR AP might prioritize backward compatibility by avoiding advanced features like TXS Mode 3 for such STAs. This ensures seamless integration with older devices while still leveraging advanced capabilities where possible, thus maintaining a robust and inclusive network environment.

Additionally, the AP could integrate these mechanisms with other Wi-Fi features, such as beamforming or OFDMA, to optimize uplink management. By considering the broader context of wireless communication, the AP can achieve efficient resource allocation across diverse standards and device capabilities.

Each of these embodiments offers distinct strategies to comply with the original constraint while enhancing network efficiency, adaptability, and user experience.

According to one embodiment, once a UHR AP has successfully transmitted an MU-RTS TXS Trigger frame with the TXS Mode subfield set to 3, indicating a successful allocation of a TXOP for a P2P group, the AP generally refrains from initiating its own transmissions within this allocated time. However, an exception to this rule is when the AP needs to transmit a PPDU that serves as an immediate response to a communication explicitly initiated and solicited by a non-AP STA that is part of the designated P2P group. This ensures that critical control or acknowledgment frames, which are essential for the ongoing communication within the P2P group, can be promptly transmitted by the AP without unnecessary delays that might arise from strict adherence to the TXOP allocation solely for the non-AP STAs. The nature of this solicited immediate response could include, but is not limited to, Block Acknowledgments (BlockAcks) in response to a data transmission from the non-AP STA or other link-layer control frames that the STA expects the AP to send as a direct consequence of its transmission.

According to one embodiment, considering the scenario where a non-AP STA within the P2P group transmits data or initiates a procedure requiring a direct and immediate response from the UHR AP, the AP is permitted to generate and transmit this response PPDU within the TXOP it has already allocated. This capability is crucial for maintaining efficient bidirectional communication within the P2P group and avoids the need for the non-AP STA to contend for channel access separately for its response, which would introduce additional overhead and latency. For instance, if a non-AP STA sends a series of data frames to another member of the P2P group using the allocated TXOP, and it expects immediate Block Acks from the AP (if the AP is acting as a forwarder or has a role in the QoS management), the AP can transmit these BlockAcks within the same TXOP. This immediate response mechanism enhances the throughput and responsiveness of the P2P communication facilitated by the UHR AP.

According to one embodiment, in a variation of the immediate response condition, the solicitation from the non-AP STA might not be a direct data transmission but rather a control frame that explicitly requests or necessitates an immediate action from the UHR AP. For example, a non-AP STA might send a control frame requesting a modification of the allocated TXOP parameters or a query about the network status relevant to the P2P group's communication. In such cases, the PPDU transmitted by the UHR AP would contain the requested information or the necessary control response, ensuring that the P2P group can dynamically manage its communication within the allocated time frame. This highlights the flexibility of the UHR protocol in allowing the AP to respond to immediate needs arising from the non-AP STAs within the TXOP dedicated to their P2P communication.

According to one embodiment, the second condition under which the UHR AP can transmit within the allocated TXOP involves a specific interaction with a TXSPG Requesting STA within the P2P group, provided the AP has advertised its support for TXOP return in TXSPG (TXOP Return Support In TXSPG subfield equal to 1). If such an AP receives a frame from a TXSPG Requesting STA that includes a CAS Control field with the RDG/More PPDU subfield set to 0, this signifies that the requesting STA is relinquishing the remainder of its opportunity to transmit and is not expecting any further immediate transmissions in the current Reverse Direction Grant (RDG) exchange. In this precise scenario, the UHR AP is granted the option to transmit its own PPDU after a Short Interframe Space (SIFS), effectively taking back the TXOP or a portion thereof.

According to one embodiment, the purpose of allowing the UHR AP to transmit after receiving a frame with the CAS Control field and RDG/More PPDU set to 0 from a TXSPG Requesting STA is to enhance channel utilization and efficiency, particularly in situations where the requesting STA has completed its immediate transmission needs but a significant portion of the allocated TXOP remains unused. By enabling the AP to reclaim the channel (after a SIFS, indicating a prioritized access), the standard allows the AP to serve other traffic, potentially related to the same P2P group or other network activities, without having to wait for the entire initially allocated TXOP duration to expire. This mechanism is especially beneficial in bursty traffic scenarios where the need for transmission time by the requesting STA might be shorter than the initial allocation.

According to one embodiment, the requirement for the UHR AP to have the TXOP Return Support In TXSPG subfield set to 1 is crucial because it indicates that the AP has explicitly advertised its capability to participate in this TXOP return mechanism within the context of TXOP sharing for P2P groups. A TXSPG Requesting STA that observes this capability advertised by the AP understands that it has the option to signal the early termination of its transmission needs using the CAS Control field and the RDG/More PPDU subfield, with the expectation that the AP might subsequently utilize the remaining TXOP. This advertised support ensures that the behavior is mutually understood and agreed upon by the communicating STAs, preventing unexpected channel access by the AP that could interfere with ongoing or anticipated transmissions by the non-AP STAs in the P2P group.

According to one embodiment, consider an example where a UHR AP allocates a 10 ms TXOP to a P2P group based on a request from STA3 (the TXSPG Requesting STA). STA3 transmits for 3 ms and then sends a frame with the CAS Control field and RDG/More PPDU set to 0, indicating it has no more immediate data to send. If the UHR AP has advertised TXOP Return Support In TXSPG, it can then transmit its own PPDU (perhaps a control frame or data destined for another STA in the P2P group) after a SIFS, utilizing the remaining 7 ms of the TXOP. Without the TXOP Return Support In TXSPG being advertised and the specific signaling from STA3, the UHR AP would have to remain silent for the remaining 7 ms, even if it had pending traffic for the P2P group or the broader network. This illustrates how the defined conditions optimize channel usage in UHR WLANs.

According to one embodiment, if the UHR AP successfully transmits an MU-RTS TXS Trigger frame with the TXS Mode subfield set to 3, it refrains from transmitting any PPDU within the allocated time unless the PPDU carries an immediate response solicited by a non-AP STA. This ensures that the AP adheres to the negotiated transmission schedule while allowing for urgent responses, such as ACKs or Block ACKs, to maintain reliable communication. For instance, if a non-AP STA sends a data frame requiring an immediate acknowledgment, the AP may transmit a PPDU containing this response without violating the TXS allocation. This mechanism balances adherence to the TXS framework with the need for timely responses.

According to another embodiment, the UHR AP is permitted to transmit a PPDU within the allocated time if it receives a frame from a TXSPG Requesting STA in the P2P group that includes a CAS Control field with the RDG/More PPDU subfield set to 0. In this case, the AP may send a PPDU SIFS after receiving such a frame. This enables efficient use of the channel by allowing the AP to respond quickly when no additional PPDU transmissions are expected from the requesting STA. For example, if the STA transmits a data frame with the RDG/More PPDU subfield set to 0, indicating no further data is pending, the AP can immediately acknowledge or respond without waiting for the TXS allocation period to expire.

According to another embodiment, the UHR AP may transmit multiple PPDUs within the allocated time if each subsequent PPDU is an immediate response solicited by a non-AP STA. This allows the AP to handle multiple urgent responses while still respecting the overall TXS framework. For instance, if multiple STAs send data frames requiring immediate acknowledgments, the AP can sequentially transmit the corresponding PPDUs, ensuring efficient channel utilization and maintaining low latency for critical traffic.

According to another embodiment, the UHR AP may prioritize certain types of immediate responses over others when transmitting PPDUs within the allocated time. For example, ACKs or Block ACKs may take precedence over other types of responses to ensure data transmission reliability. This prioritization can be implemented using a scheduling algorithm that evaluates the urgency and type of response required, ensuring optimal network performance under varying load conditions.

According to another embodiment, the UHR AP may dynamically adjust the TXS allocation period based on the received CAS Control field with the RDG/More PPDU subfield set to 0. This allows the AP to terminate the TXS allocation early if no further PPDUs are expected, freeing up the channel for other transmissions. For example, if a STA indicates no additional data is pending, the AP can reallocate the remaining time to other STAs or use it for its own transmissions, improving overall network efficiency.

According to another embodiment, the UHR AP may integrate this TXS framework with other IEEE 802.11 features, such as uplink multi-user MIMO (MU-MIMO) or orthogonal frequency division multiple access (OFDMA), to enhance performance in dense deployments. By combining these technologies, the AP can efficiently manage concurrent transmissions while adhering to the TXS constraints, ensuring high throughput and low latency for all connected devices.

According to another embodiment, the UHR AP may include additional logic to handle errors or unexpected conditions within the TXS framework. For instance, if a non-AP STA fails to respond correctly to an MU-RTS frame, the AP may extend the TXS allocation period or retransmit the trigger frame after a backoff interval. This robust error handling mechanism ensures that the TXS framework remains effective even in the presence of channel errors or STA misbehavior.

According to another embodiment, the UHR AP may utilize the TXS framework in conjunction with quality of service (QoS) mechanisms to prioritize critical traffic, such as voice or video streams. By allocating TXOPs dynamically based on QoS requirements and ensuring timely responses for urgent data, the AP can deliver a high-quality user experience while maintaining efficient channel utilization.

According to another embodiment, the UHR AP may implement a feedback mechanism where non-AP STAs provide regular updates on their buffer status or pending transmissions. This allows the AP to make informed decisions about TXS allocations and PPDU transmissions, minimizing idle periods and maximizing channel efficiency. For example, if a STA indicates it has no data to transmit, the AP can reallocate its TXOP to other STAs with pending traffic.

According to another embodiment, the UHR AP may support multiple overlapping TXS allocations for different P2P groups or spatial streams within a single TXOP. This enables simultaneous transmissions from multiple STAs while adhering to the constraints of the TXS framework. For instance, the AP can allocate separate time intervals for different groups based on their traffic requirements, ensuring efficient use of the available channel bandwidth.

According to another embodiment, the UHR AP may include mechanisms to handle cases where a non-AP STA does not adhere to the TXS allocation rules. For example, if a STA transmits outside its allocated time or violates the PPDU transmission constraints, the AP may impose penalties such as reducing future TXOP allocations or applying backoff procedures. This ensures fair channel access and prevents misbehaving STAs from degrading network performance.

According to another embodiment, the UHR AP may support coexistence with legacy 802.11 devices by ensuring that its TXS framework does not interfere with the operation of older standards. For example, the AP can intersperse TXS allocations with legacy-compatible transmissions or use mechanisms like CTS-to-Self to protect the channel from interference. This allows seamless integration of UHR devices into mixed networks while maintaining backward compatibility.

According to another embodiment, the UHR AP may leverage machine learning algorithms to optimize its TXS allocation decisions based on historical traffic patterns and STA behavior. By analyzing past transmissions, the AP can predict future traffic demands and adjust TXOP allocations accordingly, minimizing latency and improving overall network efficiency. For instance, if a particular STA consistently transmits large data bursts during specific times, the AP can preemptively allocate larger TXOPs to accommodate this traffic.

According to another embodiment, the UHR AP may extend the TXS framework to support multi-link aggregation, where a single TXOP spans multiple frequency bands or channels. This allows for more efficient utilization of available spectrum by aggregating transmissions across different links while adhering to the constraints of the TXS framework. For example, the AP can allocate TXOPs on both 5 GHz and 6 GHz bands simultaneously, ensuring high throughput for devices capable of multi-link operation.

According to another embodiment, the UHR AP may implement a dynamic allocation mechanism that adjusts TXOP durations based on channel conditions such as signal-to-noise ratio (SNR) or packet error rates. For example, if the channel quality degrades, the AP can extend TXOPs to allow for retransmissions or adjust modulation and coding schemes to maintain reliable communication. This adaptive approach ensures robust performance even in challenging wireless environments.

According to another embodiment, the UHR AP may integrate the TXS framework with advanced scheduling algorithms, such as proportional fair scheduling (PFS) or earliest deadline first (EDF), to prioritize transmissions based on their urgency or deadlines. This ensures that critical traffic meets its required latency and throughput constraints while efficiently utilizing the allocated TXOPs. For instance, real-time video streams can be prioritized over background data transfers to maintain a smooth user experience.

According to another embodiment, the UHR AP may support multiple TXS instances for different types of traffic or applications, allowing for independent allocation and management of transmission opportunities. This enables fine-grained control over network resources, ensuring that each type of traffic is handled optimally according to its specific requirements. For example, one TXS instance can be dedicated to voice traffic while another handles video streaming, each with its own set of parameters and priorities.

According to another embodiment, the UHR AP may include mechanisms for load balancing across multiple TXOPs or P2P groups to prevent any single group from monopolizing channel resources. This ensures fair access to the channel and prevents starvation of other STAs or groups. For example, if one P2P group has a high volume of traffic, the AP can allocate additional TXOPs to other groups while limiting the dominant group's allocations to maintain balance.

According to another embodiment, the UHR AP may provide detailed logging or debugging information for each TXS allocation and PPDU transmission, enabling network administrators to analyze performance and troubleshoot issues. This includes metrics such as TXOP utilization, number of PPDUs transmitted, response times, and error rates, all of which can be used to optimize the network configuration and improve user experience.

According to another embodiment, the UHR AP may support secure transmission of TXS-related frames using encryption techniques such as AES-256 or TLS to prevent eavesdropping or tampering. This ensures that sensitive information, such as buffer status reports or immediate responses, remains confidential and integrity is maintained throughout the transmission process.

According to another embodiment, the UHR AP may implement a power-saving mechanism that reduces energy consumption during TXS allocations by dynamically adjusting its transmit power based on the distance or link quality of connected STAs. For example, if a STA is nearby with a strong signal, the AP can lower its transmit power for transmissions directed to that STA while maintaining higher power for farther STAs.

According to another embodiment, the UHR AP may support integration with external devices or systems, such as network management platforms or application servers, to receive configuration updates or traffic prioritization rules. This enables centralized management of TXS allocations and ensures that the AP can adapt to changing network conditions or organizational policies in real-time.

According to another embodiment, the UHR AP may utilize beamforming techniques in conjunction with the TXS framework to enhance spatial reuse and improve transmission reliability. By steering beams towards specific STAs during their allocated TXOPs, the AP can reduce interference and increase throughput, especially in dense environments with multiple overlapping networks.

According to another embodiment, the UHR AP may implement a fallback mechanism that switches to legacy transmission modes under certain conditions, such as when a STA does not support the TXS framework or when channel conditions degrade significantly. This ensures backward compatibility and maintains network connectivity even in suboptimal scenarios.

According to another embodiment, the UHR AP may provide APIs or software development kits (SDKs) for third-party developers to integrate custom logic or applications with the TXS framework. This allows enterprises or service providers to tailor the TXS behavior to their specific needs, such as prioritizing certain types of traffic or integrating with proprietary systems.

According to another embodiment, the UHR AP may include a self-healing mechanism that automatically detects and recovers from failures in the TXS framework, such as missed allocations or corrupted frames. This involves monitoring key performance indicators (KPIs) like packet loss rate or latency and triggering recovery procedures when thresholds are exceeded, ensuring high availability and reliability of the network.

According to another embodiment, the UHR AP may support distributed coordination among multiple APs in a mesh or cluster configuration, allowing them to synchronize TXS allocations and avoid interference. This is particularly useful in large-scale deployments where overlapping coverage areas can lead to channel contention. By coordinating TXOPs across APs, the network can achieve higher efficiency and reduce latency.

According to another embodiment, the UHR AP may incorporate user-specific or application-specific parameters into the TXS framework, enabling personalized optimization of transmission schedules based on individual preferences or service level agreements (SLAs). For example, a premium user or critical application can be assigned higher priority in TXOP allocations to ensure superior performance and reliability.

According to another embodiment, the UHR AP may utilize predictive analytics to forecast future traffic patterns and adjust TXS allocations accordingly. By analyzing historical data and trends, the AP can anticipate peak usage periods or high-demand applications and allocate TXOPs proactively to meet expected demand, minimizing congestion and ensuring smooth operation during busy times.

According to another embodiment, the UHR AP may implement a token-based system for allocating TXOPs, where STAs earn tokens based on their activity levels or QoS requirements. These tokens can then be redeemed for transmission opportunities, allowing the AP to manage channel access in a fair and scalable manner while ensuring that high-priority traffic is accommodated.

According to another embodiment, the UHR AP may support dynamic reconfiguration of TXS parameters, such as TXOP duration or PPDU size, based on real-time feedback from connected STAs. This allows the network to adapt quickly to changing conditions, such as fluctuations in channel quality or variations in traffic load, ensuring optimal performance at all times.

According to another embodiment, the UHR AP may implement a hierarchical TXS framework where multiple levels of transmission scheduling are used to manage large-scale networks with numerous STAs and diverse traffic types. This involves creating a tree-like structure where higher-level TXOPs encompass multiple lower-level allocations, enabling efficient management of complex transmission schedules while maintaining scalability.

The flowcharts herein illustrate example methods or processes that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A method performed by a non-access point (AP) station (STA), the method comprising:
receiving, from an AP, a multi user (MU)-request to send (RTS) transmission opportunity sharing (TXS) trigger frame, wherein the MU-RTS TXS trigger frame includes only one user info field that is not a special user info field and wherein the non-AP STA is part of a peer to peer (P2P) group;
identifying a time allocated to the P2P group based on an allocation duration subfield in the MU-RTS TXS trigger frame; and
transmitting or receiving during the allocated time.

2. The method of claim 1, wherein the AP does not transmit a physical layer protocol data unit (PPDU) within the allocated time indicated in the MU-RTS TXS trigger frame unless the PPDU carries an immediate response that is solicited by the non-AP STA.

3. The method of claim 1, wherein the AP does not transmit a physical layer protocol data unit (PPDU) within the allocated time indicated in the MU-RTS TXS trigger frame unless the non-AP STA sent a frame including a command and status (CAS) control field with a reverse direction grant (RDG)/more PPDU subfield equal to 0.

4. The method of claim 3, wherein, when the non-AP STA transmits the frame with the CAS control field with the RDG/more PPDU subfield equal to 0, the AP transmits a short interframe space (SIFS) after the frame with the CAS control field.

5. The method of claim 1, wherein:
the non-AP STA is a transmission opportunity sharing for P2P group (TXSPG) requesting STA that requested a transmission opportunity (TXOP) for the P2P group or the non-AP STA is TXSPG non-AP STA in that group that is not the TXSPG requesting STA for that group; and
the one user info field includes identification information of the P2P Group.

6. The method of claim 1, wherein:
the allocated time is within a transmission opportunity (TXOP) of the AP, and
the allocated time is specified in the allocation duration subfield in the MU-RTS TXS trigger frame.

7. The method of claim 1, further comprising:
transmitting, to the AP, a message indicating successful receipt of the MU-RTS TXS trigger frame.

8. A method performed by an access point (AP), the method comprising:
transmitting, to an non-AP station (STA), a multi user (MU)-request to send (RTS) transmission opportunity sharing (TXS) trigger frame, wherein the MU-RTS TXS trigger frame includes only one user info field that is not a special user info field and wherein the non-AP STA is part of a peer to peer (P2P) group,
wherein an allocation duration subfield in the MU-RTS TXS trigger frame indicates a time allocated to the P2P group for transmitting or receiving during the allocated time.

9. The method of claim 8, wherein the AP does not transmit a physical layer protocol data unit (PPDU) within the allocated time indicated in the MU-RTS TXS trigger frame unless the PPDU carries an immediate response that is solicited by the non-AP STA.

10. The method of claim 8, wherein the AP does not transmit a physical layer protocol data unit (PPDU) within the allocated time indicated in the MU-RTS TXS trigger frame unless the non-AP STA sent a frame including a command and status (CAS) control field with a reverse direction grant (RDG)/more PPDU subfield equal to 0.

11. The method of claim 10, wherein, when the AP receives, from the non-AP STA, the frame with the CAS control field with the RDG/more PPDU subfield equal to 0, the AP transmits a short interframe space (SIFS) after the frame with the CAS control field.

12. The method of claim 8, wherein:
the non-AP STA is a transmission opportunity sharing for P2P group (TXSPG) requesting STA that requested a transmission opportunity (TXOP) for the P2P group or the non-AP STA is TXSPG non-AP STA in that group that is not the TXSPG requesting STA for that group; and
the one user info field includes identification information of the P2P Group.

13. The method of claim 8, wherein:
the allocated time is within a transmission opportunity (TXOP) of the AP, and
the allocated time is specified in the allocation duration subfield in the MU-RTS TXS trigger frame.

14. The method of claim 8, further comprising:
receiving, from the non-AP STA, a message indicating successful receipt of the MU-RTS TXS trigger frame.

15. A non-access point (AP) station (STA), comprising:
at least one processor including processing circuitry; and
memory storing instructions, wherein the instructions, when executed by the at least one processor individually or collectively, cause the non-AP STA to:
receive, from an AP, a multi user (MU)-request to send (RTS) transmission opportunity sharing (TXS) trigger frame, wherein the MU-RTS TXS trigger frame includes only one user info field that is not a special user info field and wherein the non-AP STA is part of a peer to peer (P2P) group;
identify a time allocated to the P2P group based on an allocation duration subfield in the MU-RTS TXS trigger frame; and
transmit or receive during the allocated time.

16. The non-AP STA of claim 15, wherein the AP does not transmit a physical layer protocol data unit (PPDU) within the allocated time indicated in the MU-RTS TXS trigger frame unless the PPDU carries an immediate response that is solicited by the non-AP STA.

17. The non-AP STA of claim 15, wherein the AP does not transmit a physical layer protocol data unit (PPDU) within the allocated time indicated in the MU-RTS TXS trigger frame unless the non-AP STA sent a frame including a command and status (CAS) control field with a reverse direction grant (RDG)/more PPDU subfield equal to 0.

18. The non-AP STA of claim 17, wherein, when the non-AP STA transmits the frame with the CAS control field with the RDG/more PPDU subfield equal to 0, the AP transmits a short interframe space (SIFS) after the frame with the CAS control field.

19. The non-AP STA of claim 15, wherein:
the non-AP STA is a transmission opportunity sharing for P2P group (TXSPG) requesting STA that requested a transmission opportunity (TXOP) for the P2P group or the non-AP STA is TXSPG non-AP STA in that group that is not the TXSPG requesting STA for that group; and
the one user info field includes identification information of the P2P Group.

20. The non-AP STA of claim 15, wherein:
the allocated time is within a transmission opportunity (TXOP) of the AP, and
the allocated time is specified in the allocation duration subfield in the MU-RTS TXS trigger frame.
